(19) United States
(12) Patent Application Publication
(10) Pub. No.: US 2025/0324475 A1
(43) Pub. Date: Oct. 16, 2025

(54) MEDIA ACCESS CONTROL ADDRESS RANDOMIZATION SUPPORT FOR MULTI-LINK DEVICES

(71) Applicant: Cisco Technology, Inc., San Jose, CA (US)

(72) Inventors: Binita Gupta, San Diego, CA (US); Jerome Henry, Pittsboro, NC (US); Brian Hart, Sunnyvale, CA (US)

(21) Appl. No.: 19/179,938

(22) Filed: Apr. 15, 2025

Related U.S. Application Data
(60) Provisional application No. 63/634,241, filed on Apr. 15, 2024.
(60) Provisional application No. 63/657,057, filed on Jun. 6, 2024.
(60) Provisional application No. 63/662,313, filed on Jun. 20, 2024.

(51) Int. Cl. H04W 76/15; H04L 61/50; H04W 84/12

(52) U.S. Cl. CPC H04W 76/15; H04L 61/50; H04W 84/12

(57) ABSTRACT

Devices and methods provide Media Access Control (MAC) address randomization support for multi-link devices. A multi-link client device transmits an Identifiable Random Media Access Control (IRM) address of the multi-link client device to a network device. The multi-link client device generates one or more wireless frames indicating the IRM address as a physical address. The IRM address in each wireless frame identifies at least one station of the multi-link client device. The multi-link client device transmits the wireless frame(s) to the network device. The network device receives and stores a first IRM address of the multi-link client device. The network device receives at least one wireless frame indicating a second IRM address as a physical address. The network device recognizes at least one station of the multi-link client device based on a match of the second IRM address with the first IRM address.

### CROSS-REFERENCE TO RELATED APPLICATIONS

This application claims the benefit of priority to these applications, U.S. Provisional Application No. 63/634,241 filed Apr. 15, 2024, U.S. Provisional Application No. 63/657,057 filed Jun. 6, 2024 and U.S. Provisional Application No. 63/662,313 filed Jun. 20, 2024, the entirety of which are incorporated herein by reference.

### FIELD

The present disclosure relates to wireless communication. More particularly, the present disclosure relates to providing Media Access Control (MAC) address randomization support for multi-link devices.

### BACKGROUND

802.11 is a family of evolving specifications for Wireless Local Area Networks (WLANs) developed and maintained by a working group of The Institute of Electrical and Electronics Engineers (IEEE). The 802.11 standard, commonly referred to as Wi-Fi, was released to provide a less complex and cost-efficient, wireless connectivity solution. As wireless technology rapidly advances, new requirements including, for example, faster speeds, improved security, privacy, lower latency, or the like, have emerged, requiring amendments to be made to the 802.11 standard. For example, the 802.11be amendment, also known as Wi-Fi 7, is a next-generation WLAN standard aiming for Extremely High Throughput (EHT) and improved latency, supporting a maximum throughput of at least 30 gigabits per second (Gbps) with a carrier frequency operation between 1 gigahertz (GHz) and 7.250 GHz, while ensuring backward compatibility and coexistence with legacy 802.11 compliant devices operating in the 2.4 GHz, 5 GHZ, and 6 GHz bands. In another example, 802.11bh is an amendment configured to determine how randomized and changing Media Access Control (MAC) address mobile client security affects the performance of wireless network services. The 802.11bh amendment aims to address impacts of MAC address randomization on conventional Wi-Fi networks and services.

Every network-connected device may be identified and tracked by a static, unique MAC address, which serves as a physical identifier for that device on a network, for example, a Wi-Fi network. To prevent tracking of the device and in turn, to enhance privacy and security, the MAC address of the device may be randomized. MAC address randomization may include generating a Randomly Changing MAC (RCM) address each time the device connects to the Wi-Fi network. With MAC address randomization, a station, herein referred to as a “STA,” for example, a client device, may change its MAC address at any time before association. After its initial association, in a non-Multi-Link Operation (non-MLO), the STA may provide an Identifiable Random MAC (IRM) address to an Access Point (AP) as soon as the STA has a secure link to the AP, which may be utilized by the STA in its next association and pre-association exchanges with the AP. When the STA subsequently performs a scan, or a Fine Time Measurement (FTM), or any other pre-association exchange where the STA seeks to be recognized, or reassociates, the STA may utilize the IRM address in one or more wireless frames to help the AP recognize the STA as a previously-associated STA. On the other hand, for a Multi-Link Operation (MLO), a non-AP Multi-Link Device (MLD) may include multiple affiliated STAs, each of which may utilize an STA MAC address in a wireless frame when transmitting the wireless frame to the AP. Unlike non-MLO operations, non-AP MLDs may face difficulties in being reliably recognized by access points.

### SUMMARY OF THE DISCLOSURE

Devices and methods for providing Media Access Control (MAC) address randomization support for multi-link devices in accordance with embodiments of the disclosure are described herein. In many embodiments, a multi-link client device comprises a plurality of stations, one or more processors, a network interface controller configured to provide access to a network, and a memory communicatively coupled to the one or more processors. The memory comprises a communication logic that is configured to transmit an Identifiable Random MAC (IRM) address of the multi-link client device and generate one or more wireless frames indicating the IRM address as a physical address. The IRM address in each wireless frame of the one or more wireless frames identifies at least one station of the plurality of stations. The communication logic is further configured to transmit the one or more wireless frames.

In a number of embodiments, a wireless frame of the one or more wireless frames corresponds to one of: an action frame, a public action frame, a probe request frame, a multi-link probe request frame, an access network query protocol frame, a pre-association request frame, an authentication frame, an association request frame, or a reassociation request frame.

In a variety of embodiments, the transmission of the IRM address comprises transmitting the IRM address in an IRM key delivery element of another wireless frame.

In various embodiments, the communication logic is further configured to sequentially transmit the one or more wireless frames via the plurality of stations.

In more embodiments, the communication logic is further configured to simultaneously transmit the one or more wireless frames via the plurality of stations.

In additional embodiments, the plurality of stations is implemented through one or more radios.

In further embodiments, based on the one or more radios including a plurality of radios, the communication logic is further configured to sequentially utilize the IRM address as the physical address across the plurality of stations for the transmission of the one or more wireless frames.

In still more embodiments, the IRM address is indicated as the physical address in a transmitter address field of the one or more wireless frames.

In still further embodiments, the IRM address is indicated as the physical address in a multi-link device MAC address field of the one or more wireless frames.

In still additional embodiments, the multi-link device MAC address field is included in a multi-link element of the one or more wireless frames.

In some more embodiments, the multi-link element corresponds to one of a basic multi-link element or a probe request multi-link element.

In yet various embodiments, the transmission of the one or more wireless frames is for one of a multi-link operation or a non-multi-link operation.

In yet more embodiments, based on the transmission of the one or more wireless frames for the multi-link operation, the IRM address is indicated as the physical address in a multi-link device MAC address field of the one or more wireless frames.

In still yet more embodiments, the communication logic is further configured to transmit, for the non-multi-link operation, a new wireless frame indicating the IRM address in a transmitter address field of the new wireless frame.

In many further embodiments, based on the transmission of the one or more wireless frames for the non-multi-link operation, the IRM address is indicated as the physical address in a transmitter address field of the one or more wireless frames.

In many additional embodiments, the communication logic is further configured to transmit, for the multi-link operation, a new wireless frame indicating the IRM address in a multi-link device MAC address field of the new wireless frame.

In still yet further embodiments, a network device comprises one or more processors, a network interface controller configured to provide access to a network, and a memory communicatively coupled to the one or more processors. The memory comprises a communication logic that is configured to receive a first IRM address of a multi-link client device, store the first IRM address of the multi-link client device in the memory, receive at least one wireless frame indicating a second IRM address as a physical address, and recognize at least one station of the multi-link client device based on a match of the second IRM address with the first IRM address.

In still yet additional embodiments, the at least one wireless frame corresponds to one of: an action frame, a public action frame, a probe request frame, a multi-link probe request frame, an access network query protocol frame, a pre-association request frame, an authentication frame, an association request frame, or a reassociation request frame.

In several embodiments, the reception of the at least one wireless frame is for one of a multi-link operation or a non-multi-link operation.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a wireless local area networking system in accordance with various embodiments of the disclosure;

FIG. 2 is a conceptual network diagram of various environments in which a communication logic may operate on a plurality of network devices in accordance with various embodiments of the disclosure;

FIG. 3 is a block diagram of a system illustrating communication between multi-link devices and non-multi-link devices in accordance with various embodiments of the disclosure;

FIG. 4 is a schematic illustration of a format of a wireless frame including a key delivery element for transmitting one or more Identifiable Random Media Access Control (IRM) addresses in accordance with various embodiments of the disclosure;

FIG. 5 is a schematic illustration of a format of an IRM element for transmitting one or more IRM addresses in accordance with various embodiments of the disclosure;

FIG. 6 is a schematic illustration of a format of an IRM frame action field for transmitting one or more IRM addresses in accordance with various embodiments of the disclosure;

FIG. 7 is a schematic illustration of a format of a presence bitmap field of a probe request multi-link element in accordance with various embodiments of the disclosure;

FIG. 8 is a schematic illustration of a multi-link element including a multi-link control field and a common information field in accordance with various embodiments of the disclosure;

FIG. 9 is a flowchart depicting a process for providing Media Access Control (MAC) address randomization support for a multi-link client device in accordance with various embodiments of the disclosure;

FIG. 10 is a flowchart depicting a process for providing MAC address randomization support for a multi-link client device including one or more radios in accordance with various embodiments of the disclosure;

FIG. 11 is a flowchart depicting a process for recognizing at least one station of a multi-link client device in accordance with various embodiments of the disclosure;

FIG. 12 is a flowchart depicting a process for signaling one or more IRM addresses between multi-link operation and non-multi-link operation transitions in accordance with various embodiments of the disclosure; and

FIG. 13 is a conceptual block diagram of a device suitable for configuration with a communication logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, devices and methods are discussed herein for providing Media Access Control (MAC) address randomization support for multi-link devices. MAC address randomization may be implemented to provide privacy to devices and to preclude third parties from tracking the devices while allowing trusted parties to identify the devices. MAC address randomization may include generating a Randomly Changing MAC (RCM) address, also referred to as a “Randomized and Changing MAC (RCM) address,” configured to identify a device each time the device connects to a network. The network may, for example, be a Wireless Local Area Network (WLAN) that implements Wi-Fi® of Wi-Fi Alliance Corporation, herein referred to as a “Wi-Fi network.” The RCM address may refer to a type of MAC address, for example, an Identifiable Random MAC (IRM) address that may be configured to be both randomized for privacy of the device and still be identifiable by the network to which the device connects. The devices and methods discussed herein support MAC address randomization for multi-link devices, for example, multi-link client devices. Multi-link client devices may refer to client devices or stations, herein referred to as “STAs,” capable of utilizing multiple wireless links or frequency bands simultaneously to communicate with the network. The multi-link client devices may, for example, be IEEE 802.11 client devices that may incorporate multiple radios, each radio operating on a different frequency band or channel and maintaining communications with a corresponding radio on a network device such as an Access Point (AP) that operates in that frequency band. For example, a multi-link client device may include one radio that supports a first radio link to an AP in the 5 GHz band and another radio that supports a second radio link to the same AP in the 6 GHz band, or one radio that supports two radio links both in the 5 GHz band.

Multi-Link Operation (MLO) may refer to a Wi-Fi technology that allows compatible client devices, for example, the multi-link client devices, connected to a network device such as an AP, to simultaneously operate across multiple channels in different frequency bands including, for example, the 2.4 gigahertz (GHz) band, the 5 GHz band, and the 6 GHz band, and maintain simultaneous connections to the frequency bands on a single AP. With the MLO, multiple wireless links may be established between the multi-link client device and one or more APs of the network. The MLO may allow the simultaneous use of multiple frequency bands. Instead of switching between the frequency bands, MLO-enabled, multi-link client devices may remain associated with multiple wireless links and select an optimal wireless link(s) for transmitting and receiving data, thereby facilitating reduction of latency, improvement of connection stability, and in some cases, increase of throughput. The MLO may, therefore, allow the multi-link client devices connected to the AP to simultaneously transmit and/or receive data across different frequency bands and channels. The MLO may aggregate multiple channels on different frequency bands at the same time, negotiating seamless network traffic even if there is an interference or a congestion in the network.

The MLO, for example, in Wi-Fi 7, may relate to one station, herein referred to as a “STA,” communicating with one AP over multiple radios and frequency bands at the same time, thereby allowing the AP and the STA to transmit data simultaneously over two radios at the same time. These radios may operate, for example, on either the 2.4 GHz band, the 5 GHz band, or the 6 GHz band, with the AP and the STA selecting one or more frequency bands that work best at the time of the transmission. For example, the STA may utilize the 2.4 GHz band for control messages, the 5 GHz band for medium-speed data, and the 6 GHz band for high-speed data. Connecting to the 2.4 GHZ, 5 GHZ, and 6 GHz bands may simultaneously increase throughput, reduce latency, and improve reliability, which may be optimal for emerging applications such as Virtual Reality/Augmented Reality (VR/AR), online gaming, remote office, cloud computing, etc. In contrast to the MLO, a non-Multi-Link Operation (non-MLO) may refer to a communication scenario where a device or network connection utilizes only a single wireless link or a single frequency band, for example, the 2.4 GHz band or the 5 GHz band, at a time to transmit and receive data.

With MAC address randomization, an STA may change its MAC address at any time before association. Association may refer to a process by which the STA connects to and establishes a wireless session through a wireless communication link with an AP. In an example scenario, after an initial association, in a non-MLO, the STA may provide an IRM address to the AP as soon as the STA has a secure link to the AP, for example, during a four-way handshake, which may be utilized by the STA in its next association and pre-association exchanges with the AP. When the STA subsequently performs a scan, or a Fine Time Measurement (FTM), or any other pre-association exchange where the STA seeks to be recognized, or reassociates, the STA may utilize the IRM address in a Transmitter Address (TA) field in one or more wireless frames. The IRM address in the TA field of one or more wireless frames may help the AP to recognize the STA as a previously-associated STA. For a new association, the AP can then apply cached information or a shared identity state from the previous association to the new association. The IRM address may, therefore, be useful for recognizing the STA prior to the association, for example, during scanning.

An AP capable of an MLO may be referred to as an AP Multi-Link Device (MLD) and may include multiple AP instances, also herein referred to as “APs,” each configured to communicate on a respective wireless link. For an MLO, a non-AP MLD, that does not operate as an AP, may include multiple affiliated STAs. The non-AP MLD may also be referred to as a “client device,” a “station MLD,” or a “STA MLD,” and may include multiple STA instances, also referred to as “STAs,” each configured to communicate with a respective AP of the AP MLD using a respective wireless link. Each of the affiliated STAs of the non-AP MLD may utilize an STA MAC address in a TA field of a wireless frame when transmitting the wireless frame to the AP. If a single IRM address is established for the non-AP MLD, as in the non-MLO, then each affiliated STA of the non-AP MLD may not have a different IRM address to utilize for identification, for example, when performing a probe scan, and hence cannot be recognized by the AP. A probe scan may refer to a scanning process where a device, for example, a non-AP MLD, searches for available APs by transmitting probe request frames to detect nearby networks. Conventional methods do not support RCM for an MLD, thereby precluding each of the affiliated STAs of the non-AP MLD from being recognized before association, for example, in a probe request. Further, enhancements may be needed when a non-AP MLD transitions between MLO and non-MLO associations.

In many embodiments, the devices and methods discussed herein provide enhancements to support RCM for an MLD, for example, a multi-link client device such as a non-AP MLD, using an IRM mechanism for an MLO. In a number of embodiments, similar to an STA in the case of a non-MLO, the non-AP MLD may provide a single IRM address to an AP MLD, for example, in Message 4 of a four-way handshake, using an IRM Key Delivery Element (KDE) defined in the 802.11bh amendment. The AP MLD may utilize this single IRM address to recognize the non-AP MLD in a subsequent association or in pre-association messaging such as a probe request. In the case of the MLO, in a variety of embodiments, the multi-link client device may include a single radio and may be referred to as a “single-radio client device.” The single-radio client device may perform active scanning, for example, by transmitting a probe request frame, using the same radio across multiple frequency bands, for example, the 2.4 GHz band, the 5 GHz band, and the 6 GHz band, one by one. In this case, the single-radio client device may utilize the same IRM address as a transmitter address in the TA field of each wireless frame when scanning across multiple frequency bands. In various embodiments, the multi-link client device may include multiple radios for different bands, for example, one radio for the 2.4 GHz band and another radio for the 5 GHz band or the 6 GHz band, and may be referred to as a “multi-radio client device.” For a multi-radio client device that cannot perform scanning using the same radio on all frequency bands, in more embodiments, the multi-radio client device may perform scanning by utilizing only one radio at a time and by utilizing the IRM address as the transmitter address in the TA field of a wireless frame on that radio operating, for example, at 2.4 GHz. The multi-radio client device may then pass the IRM address to the other radio operating, for example, at 5 GHz or 6 GHz, and utilize the same IRM address to perform scanning on the other frequency bands, for example, the 5 GHz band or the 6 GHz band, thereby allowing the AP MLD to recognize an STA of the multi-radio client device because a recognized IRM address is utilized in every probe request frame transmitted for active scanning. The multi-radio client device may perform scanning with one radio at a time using the same IRM address across the radios.

In additional embodiments, the multi-radio client device can perform scanning in parallel by utilizing multiple radios. In these embodiments, only one of the radios may utilize the IRM address as the transmitter address when scanning. Each of the other radios may utilize a different IRM address which may not be recognized by the AP MLD. This approach may only allow the AP MLD to recognize the IRM address of one of the STAs of the multi-radio client device in a pre-association scan. A pre-association scan may refer to an initial network discovery process where an STA searches for available networks before attempting to associate with an AP. In further embodiments, the multi-radio client device may utilize the same IRM address as the transmitter address for its pre-association traffic on multiple radios. The STAs of this multi-radio client device may, therefore, appear as a single MAC address over multiple frequency bands to the AP MLD. As the STAs are on the same multi-radio client device, the duplication of the MAC address is a non-issue. In still more embodiments, both a single-radio client device or a multi-radio client device may utilize the IRM address, which is recognized by the AP MLD, as the transmitter address from one of the radios to transmit a multi-link probe request frame to one of the APs affiliated with the AP MLD.

In still further embodiments, when the multi-radio client device, for example, a non-AP MLD, transmits a subsequent association request frame or a reassociation request frame on one of the wireless links between the non-AP MLD and the AP MLD, the non-AP MLD may utilize the IRM address as the transmitter address in either request frame, regardless of the wireless link on which either request frame is transmitted. The association request frame or the reassociation request frame may herein be referred to as the “(re)association request frame.” In still additional embodiments, the IRM address may be utilized as the transmitter address in the TA field in the (re)association request frame, whichever request frame is transmitted by the non-AP MLD, such that the AP MLD can recognize the non-AP MLD from the previous association.

In some more embodiments, the multi-radio client device, for example, a non-AP MLD, may provide multiple, link level IRM addresses, one for each radio or frequency band supported by the non-AP MLD. In an example scenario, as part of an initial association within an Extended Service Set (ESS), the non-AP MLD may transmit multiple IRM addresses in one or more IRM KDEs, one IRM address for each of its supported radios or frequency bands in Message 4 of the four-way handshake with the AP MLD. The AP MLD may receive and store the transmitted IRM addresses for that non-AP MLD. Subsequently, when the non-AP MLD performs a pre-association scan by utilizing its multiple radios in parallel, the non-AP MLD may utilize each of the IRM addresses as the transmitter address for recognition by the AP MLD. The AP MLD may utilize each of the IRM addresses to recognize the non-AP MLD. In yet various embodiments, for a subsequent association, the non-AP MLD may utilize one of the IRM addresses previously provided to the AP MLD as the transmitter address in a (re)association request frame on one of the wireless links established with the AP MLD, allowing the AP MLD to recognize the non-AP MLD from the previous association.

In yet more embodiments, if a non-AP MLD receives a duplicate IRM frame from the AP MLD, the non-AP MLD may transmit a new IRM frame to the AP MLD to provide a new set of IRM addresses. In still yet more embodiments, the new IRM frame may be an extension of the new IRM frame defined in the 802.11bh amendment. In many further embodiments, the new IRM frame may be configured as a new MLO IRM frame to allow a non-AP MLD to provide multiple IRM addresses in that frame, one for each of its supported radios or frequency bands.

In many additional embodiments, for enhanced privacy, a non-AP MLD may also change its MLD MAC address to an RCM, since the MLD MAC address is carried in a basic multi-link element in a (re)association request frame in an unprotected form and can be utilized to identify the non-AP MLD. When the AP MLD receives the (re)association request frame with a link level IRM address in the TA field, the AP MLD may utilize the link level IRM address to connect the non-AP MLD with any previously stored cached states including MLD specific states, if any. In these embodiments, a separate MLD level IRM address for identification of the non-AP MLD may not be needed.

In still yet further embodiments, the devices and methods discussed herein may also support use of an RCM address, for example, an IRM address, when a multi-link client device such as a non-AP MLD, transitions from an MLO association to a non-MLO association and vice versa. The devices and methods discussed herein may signal the IRM address between MLO and non-MLO transitions. In a first example case scenario, the non-AP MLD may perform a multi-link setup with an AP MLD. In the multi-link setup, one or more radios of the non-AP MLD may communicate with the AP MLD simultaneously over different wireless links at the same time. In this example case scenario, the non-AP MLD may provide the IRM address that identifies the non-AP MLD, as part of the multi-link setup, during a four-way handshake. Subsequently, in still yet additional embodiments, the non-AP MLD may provide the IRM address in non-MLO pre-association frames. When one of the affiliated STAs of the non-AP MLD transmits a pre-association request frame, for example, a probe request frame, an Access Network Query Protocol (ANQP) frame, or the like, which is not MLO or MLD specific, then the affiliated STA may operate as a non-MLD STA. In this case, in accordance with the 802.11be amendment, the MAC address of the STA may be set to the MLD MAC address. Hence, the IRM address previously provided for the non-AP MLD can be utilized by the affiliated STA of the non-AP MLD, if the affiliated STA intends to reveal its identity. In that case, the MAC address in the TA field of the pre-association frame can be set to the IRM address previously provided during the multi-link setup, if the affiliated STA intends to be recognized by the AP MLD. When transmitting the non-MLO pre-association frames, the affiliated STA of the non-AP MLD transmitting a non-MLO pre-association frame may set the MAC address in the TA field of the non-MLO pre-association frame to the IRM address previously provided to the AP MLD in the same ESS, when the affiliated STA intends to be identified.

Further, in several embodiments, the non-AP MLD may provide the IRM address in MLO-specific pre-association frames. When one of the affiliated STAs of the non-AP MLD transmits an MLO-specific pre-association frame, for example, a multi-link probe request frame that includes a probe request multi-link element, the IRM address can be provided in one of the following: (a) the TA field; or (b) a multi-link element. In several more embodiments, the affiliated STA of the non-AP MLD may provide the IRM address in the TA field of the multi-link probe request frame, which may keep the presence of the IRM address ambiguous and preclude an observer from determining that the MAC address in the TA field is the IRM address, because the TA field is always present whether the IRM address is utilized or not. In numerous embodiments, the affiliated STA of the non-AP MLD, when transmitting a multi-link probe request frame, may provide the IRM address in an MLD MAC address field of a basic multi-link element. In numerous additional embodiments, the affiliated STA of the non-AP MLD may include the basic multi-link element only in the multi-link probe request frame, which is an MLO-specific pre-association frame. In further additional embodiments, the affiliated STA of the non-AP MLD may include the basic multi-link element only if both the non-AP MLD and the AP MLD have declared support for the IRM mechanism. In many embodiments, for a multi-link probe request, a non-AP MLD may only include the basic multi-link element if the basic multi-link element has a “dot11IRMActivated” value equal to true and the AP MLD has an IRM active field set to a value of “1” in an Extended Robust Security Network (RSN) Capabilities field in beacon and probe response frames transmitted by all the affiliated APs of the AP MLD. In a number of embodiments, the basic multi-link element may not be included in a non-multi-link probe request.

In a variety of embodiments, the probe request multi-link element of the multi-link probe request frame can be enhanced to include an MLD MAC address. In these embodiments, the affiliated STA of the non-AP MLD may provide the IRM address as the MLD MAC address in the probe request multi-link element. In various embodiments, the probe request multi-link element can be enhanced to include the MLD MAC address of an originator non-AP MLD which can then be set to the IRM address provided by the non-AP MLD in the previous multi-link setup, to provide the IRM address to the AP MLD. In these embodiments, a new present field may be added in a presence bitmap field to indicate a presence of a non-AP MLD MAC address in the probe request multi-link element. In more embodiments, this new present field may be set to a value of “1” only when the IRM mechanism is activated and the AP MLD has indicated support for the IRM mechanism. When the new present field is set to the value of “1”, the non-AP MLD may include the IRM address as the non-AP MLD MAC address in a common information field of the probe request multi-link element. The AP MLD can then utilize the IRM address to recognize the non-AP MLD.

In additional embodiments, when the same non-AP MLD performs an association with a non-MLO AP in the same ESS, an authentication request frame and a (re)association request frame may not include any basic multi-link element. In further embodiments, the IRM address previously provided to another AP MLD in the same ESS may be utilized to set the TA field in the authentication frame and the (re)association request frame transmitted to the non-MLO AP, if the affiliated STA of the non-AP MLD intends to be recognized by the non-MLO AP.

In still more embodiments, a non-AP MLD that previously provided an IRM address to an AP MLD in an ESS and later associates with an AP within the same ESS, may provide that IRM address as the MAC address in the TA field in the authentication and (re)association request frames if the non-AP MLD intends to be identified by the AP in that ESS. In still further embodiments, when the non-AP MLD later performs another multi-link setup with an AP MLD in the same ESS, where the non-AP MLD provided the IRM address in the last multi-link association, the non-AP MLD may set the IRM address in the MLD MAC address field in the basic multi-link element of the authentication and (re)association request frames. In still additional embodiments, the non-AP MLD can also set the same IRM address in the TA field of the authentication and (re)association request frames, since the 802.11be draft amendment allows the STA MAC address and the MLD MAC address to be the same. In some more embodiments, when transmitting MLD level frames to another AP MLD including a multi-link probe request frame, an authentication request frame, and an association request frame, the non-AP MLD may set the MLD MAC address field in the basic multi-link element of each of the frames to the provided IRM address when the non-AP MLD intends to be identified.

In a second example case scenario, an affiliated STA of a non-AP MLD may associate with a non-MLO AP and provide an IRM address that identifies the non-AP MLD during a four-way handshake. When the same affiliated STA of the same non-AP MLD later establishes a multi-link association with an AP MLD in the same ESS, using the multi-link setup, the non-AP MLD may utilize the MAC address of the affiliated STA as the MLD MAC address, in accordance with the 802.11be amendment. Hence, the MLD MAC address in the basic multi-link element in the authentication request frame and the (re)association request frame for the multi-link setup can be set to the IRM address that was previously provided during the non-multi-link association with the non-MLO AP. In yet various embodiments, the transmitter address in the authentication request frame and the (re)association request frame can also be set to the IRM address, since the IRM address may also correspond to the MAC address of the affiliated STA. Similarly, in yet more embodiments, in any multi-link-specific pre-association frame, for example, a multi-link probe request frame, the MAC address of the non-AP MLD either in a probe request multi-link element or a basic multi-link element can be set to the IRM address that was previously provided by the non-AP MLD to the non-MLO AP in the same ESS. This is for the same reason as above, where the non-AP MLD utilizes the MAC address of the affiliated STA as the MLD MAC address when the affiliated STA later associates to an AP MLD in accordance with the 802.11be amendment.

In still yet more embodiments, an affiliated STA of a non-AP MLD that previously provided an IRM address to an AP in an ESS and later associates with an AP MLD within the same ESS, may provide that IRM address as its MLD MAC address in the basic multi-link element of the multi-link probe request frame, the authentication request frame, and the (re)association request frame if the affiliated STA intends to be identified by the AP MLD in that ESS. In many further embodiments, in both the example case scenarios above, the non-AP MLD may set the IRM address provided previously both in the TA field and in the MLD MAC address field of the basic multi-link element in the pre-association frames such as the multi-link probe request frame, the authentication request frame, and the (re)association request frame. For any non-MLO pre-association frame, for example, a non-multi-link probe request frame or an ANQP frame, the TA field of the non-MLO pre-association frame may be set to the IRM address, independent of whether the IRM address was provided as part of an MLO association or a non-MLO association, which may optimize the logic of the multi-link client device. This may also optimize the logic of the AP, since if the non-AP MLD sets both the TA field and the MLD MAC address field to the IRM address, then the AP may merely inspect the TA field to find the IRM address to recognize the affiliated STA of the non-AP MLD.

In many additional embodiments, for MLO, if a non-AP MLD has previously provided an IRM address to an AP MLD in an ESS and the non-AP MLD transmits an authentication frame using that IRM address as the MLD MAC address to any AP MLD in the ESS, then the AP MLD receiving the authentication frame can identify the corresponding non-AP MLD before association is started or completed.

A non-AP MLD that stores a newly allocated IRM address that was previously provided to an AP MLD in an ESS and later becomes a non-AP STA for the purpose of communicating with an AP in the same ESS, may provide that IRM address as its MAC address in the TA field of a wireless frame. Similarly, a non-AP STA that stores a newly allocated IRM address that was previously provided to an AP in an ESS and later becomes a non-AP MLD for the purpose of communicating with an AP MLD in the same ESS, may provide that IRM address as its MLD MAC address in a wireless frame. For MLO, a non-AP MLD may change its IRM address in each association and may utilize the IRM addresses for its affiliated non-AP STAs. A non-AP MLD becomes a non-AP STA for the purpose of communicating with an AP when transmitting regular probe request frames, directed or broadcast, and public action frames. If a non-AP MLD associated with an AP MLD provides an IRM address and later transmits regular probe request frames which are non-multi-link probe requests or public action frames, the non-AP MLD may be acting as a non-AP station, and in that case, may utilize that IRM address in the TA field of each probe request frame.

MAC address randomization may be implemented to provide privacy to multi-link devices and to preclude third parties from tracking the multi-link devices while allowing trusted parties to identify the multi-link devices. MAC address randomization may help mitigate surveillance efforts that rely on tracking a static MAC address. Moreover, MAC address randomization may help mask a location of a multi-link client device by generating random MAC addresses for each network connection. Randomizing the MAC address each time a multi-link device connects to a network may prevent the tracking of the multi-link devices across different networks, reduce the risk of multi-link device profiling, limit multi-link device fingerprinting, and enhance overall network security. Further, MAC address randomization may also limit targeted attacks, ensure compliance with privacy regulations, and improve security in public Wi-Fi environments, making it substantially useful in modern wireless technology.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. Nevertheless, the executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in more embodiments, may alternatively be embodied by or implemented as a component.

A circuit, as used herein, comprises a set of one or more electrical and/or electronic components providing one or more pathways for electric current. In additional embodiments, a circuit may include a return pathway for electric current, so that the circuit is a closed loop. In further embodiments, however, a set of components that does not include a return pathway for electric current may be referred to as a circuit (e.g., an open loop). For example, an integrated circuit may be referred to as a circuit regardless of whether the integrated circuit is coupled to ground (as a return pathway for electric current) or not. In still more embodiments, a circuit may include a portion of an integrated circuit, an integrated circuit, a set of integrated circuits, a set of non-integrated electrical and/or electrical components with or without integrated circuit devices, or the like. In still further embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a PCB or the like. Each of the functions and/or modules described herein, in still additional embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

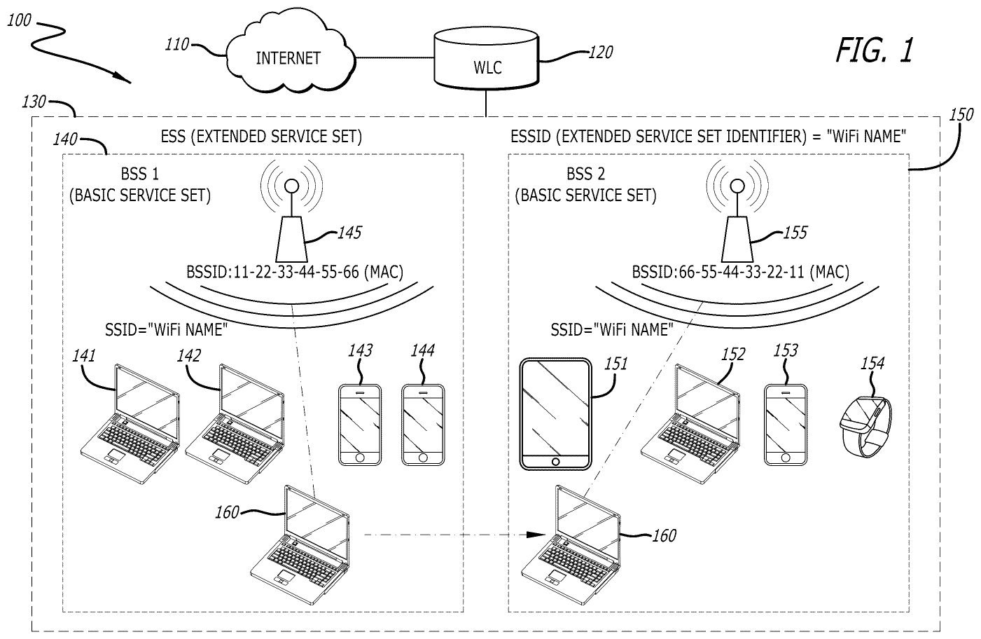

Referring to FIG. 1, a schematic diagram of a wireless local area networking system 100 in accordance with various embodiments of the disclosure is shown. The wireless local area networking system 100 may allow seamless communication and connectivity between various devices within localized areas based on wireless local area networking standards. One of these wireless local area networking standards may, for example, be Wi-Fix of the Wi-Fi Alliance Corporation, which is based on the IEEE 802.11 family of protocols. The Institute of Electrical and Electronics Engineers (IEEE) developed the IEEE 802.11 family of protocols for Wireless Local Area Networks (WLANs), for example, Wi-Fi networks. Wi-Fi provides high-speed wireless access to the internet and local network resources, with standards such as 802.11a, 802.11b, 802.11g, 802.11n, 802.11ac, 802.11ad, 802.11ax, and 802.11be, each offering improvements in speed, range, latency, throughput, and efficiency. Each adoption of Wi-Fi standards is often designed to generate enhanced performance, increased capacity, and better efficiency in crowded network environments. Other standards can be utilized for short-range wireless communication between devices, particularly in the realm of Personal Area Networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a role in defining and organizing wireless network devices. A service set may refer to a collection of wireless devices that share a common Service Set Identifier (SSID). The SSID, often recognizable to users as a network name presented in a natural language, serves as a means of identification and differentiation among various wireless networks. Within a service set, nodes comprising devices, for example, laptops, smartphones, or other Wi-Fi-enabled devices operate collaboratively, adhering to shared link-layer networking parameters. These link-layer networking parameters encompass specific communication settings and protocols that facilitate seamless interaction among the devices within the service set. The service set may form a cohesive and logical network segment, creating an organized structure for wireless communication where the devices can communicate and share data within defined parameters, enhancing the efficiency and coordination of wireless networking operations.

In the context of wireless local area networking standards, a service set can be configured in two distinct forms: a Basic Service Set (BSS) or an Extended Service Set (ESS). The BSS represents a subset within a service set, including devices that share common physical layer medium access characteristics. These characteristics include parameters such as radio frequency, modulation scheme, and security settings, ensuring seamless wireless networking among the devices. The BSS is uniquely identified by a Basic Service Set Identifier (BSSID), a 48-bit label adhering to MAC-48 conventions. Despite the possibility of a device having multiple BSSIDs, each BSSID is typically associated with, at most, one BSS at any given time.

A BSS should not be misconstrued as a coverage area of an Access Point (AP), which is referred to as a Basic Service Area (BSA). The BSA encompasses a physical space within which an AP provides wireless coverage, while the BSS focuses on a logical grouping of devices sharing common networking characteristics. The distinction emphasizes that the BSS is a conceptual grouping based on shared communication parameters, while the BSA defines a spatial extent of a wireless reach of an AP. These distinctions may be useful for configuring and managing wireless networks, ensuring optimal performance and coordination among connected devices.

The SSID defines a service set or an ESS. The SSID is typically broadcast in beacon frames by APs to announce the presence of a network and may be viewed by users as a wireless network name. Unlike BSSIDs, SSIDs are usually customizable. Since the contents of an SSID field are arbitrary, the 802.11 standard permits devices to advertise the presence of a wireless network with beacon frames. A station (STA) may also likewise transmit frames in which the SSID field is set to null; this prompts an associated AP to transmit a list of supported SSIDs to the STA. Once a device has associated with a BSS, for efficiency, the SSID is not transmitted within packet headers; only the BSSIDs are utilized for addressing.

An ESS is a more sophisticated wireless network architecture configured to provide seamless coverage across a larger area, typically spanning environments such as homes or offices that may be too expansive for reliable coverage by a single AP. The ESS is created through a collaboration of multiple APs, presenting itself to users as a unified and continuous network experience. The ESS operates by integrating one or more infrastructure BSSs within a common logical network segment, characterized by sharing the same Internet Protocol (IP) subnet and Virtual Local Area Network (VLAN). The concept of an ESS is particularly utilized in scenarios where a single AP cannot adequately cover the entire desired area. By employing multiple APs strategically, users can move seamlessly across the ESS without experiencing disruptions in connectivity, thereby maintaining a consistent wireless experience in larger spaces, where the users may transition between different physical locations covered by distinct APs.

Moreover, ESSs offer additional functionalities such as distribution services and centralized authentication. The distribution services facilitate an efficient distribution of network resources and services across the entire ESS. Centralized authentication enhances security and simplifies access control by allowing users to authenticate once for access to any part of the ESS, streamlining the user experience and network management. ESSs, therefore, provide a scalable and robust solution for ensuring reliable and comprehensive wireless connectivity in diverse and expansive environments.

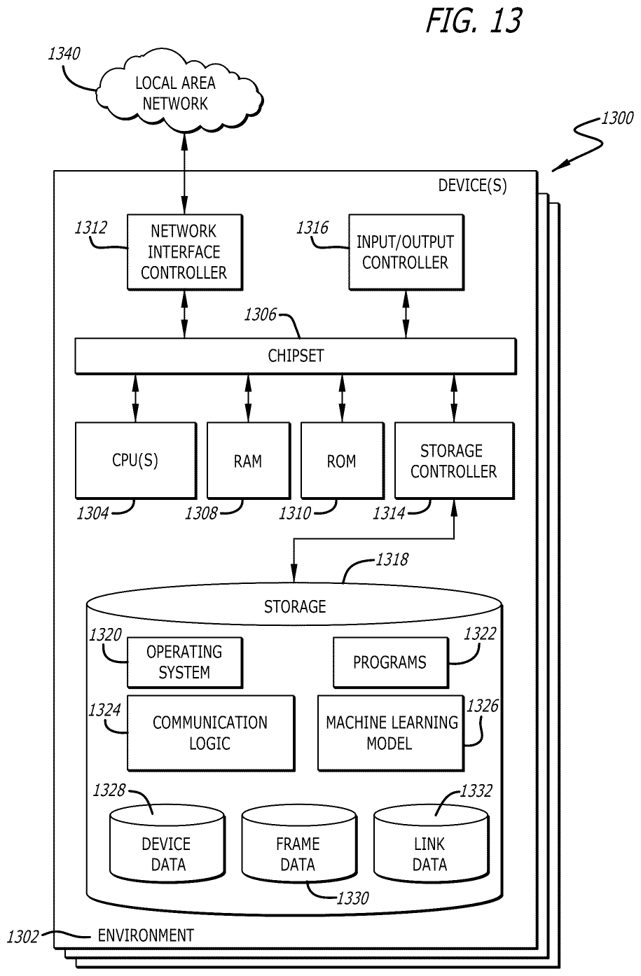

The network can include a variety of user end devices that connect to the network. These devices can sometimes be referred to as stations (STAs). Each device is typically configured with a Medium Access Control (MAC) address in accordance with the IEEE 802.11 standard. As disclosed in the description of FIG. 13, various devices on a network can include components such as a processor, a transceiver, a user interface, etc. These components can be configured to process frames of data transmitted and/or received over a network. APs are wireless devices configured to provide access to user end devices to a larger network, such as the Internet 110.

In the embodiment depicted in FIG. 1, a wireless network controller 120, for example, a WLAN controller (shown as WLC 120), is connected to a public network such as the Internet 110. The WLC 120 is in communication with an ESS 130. The ESS 130 comprises two separate basic service sets, for example, BSS 1 140 and BBS 2 150. The ESS 130, the BSS 1 140, and the BSS 2 150 all broadcast and are configured with the same SSID “Wi-Fi Name”, which can be a BSSID for each of the BSS 1 140 and the BSS 2 150 as well as an Extended Service Set Identifier (ESSID) for the ESS 130.

Within the first BSS 1 140, the network comprises a plurality of devices, for example, a first notebook 141, a second notebook 142, a first phone 143, a second phone 144, and a third notebook 160. Each of these devices can communicate with a first AP 145. Likewise, within the second BSS 2 150, the network comprises a plurality of devices, for example, a first tablet 151, a fourth notebook 152, a third phone 153, and a first watch 154. Each of these devices can communicate with a second AP 155. The third notebook 160 is communicatively connected to both the first BSS 1 140 and the second BSS 2 150. In this setup, the third notebook 160 can be seen to roam from a physical area serviced by the first BSS 1 140 into a physical area serviced by the second BSS 2 150.

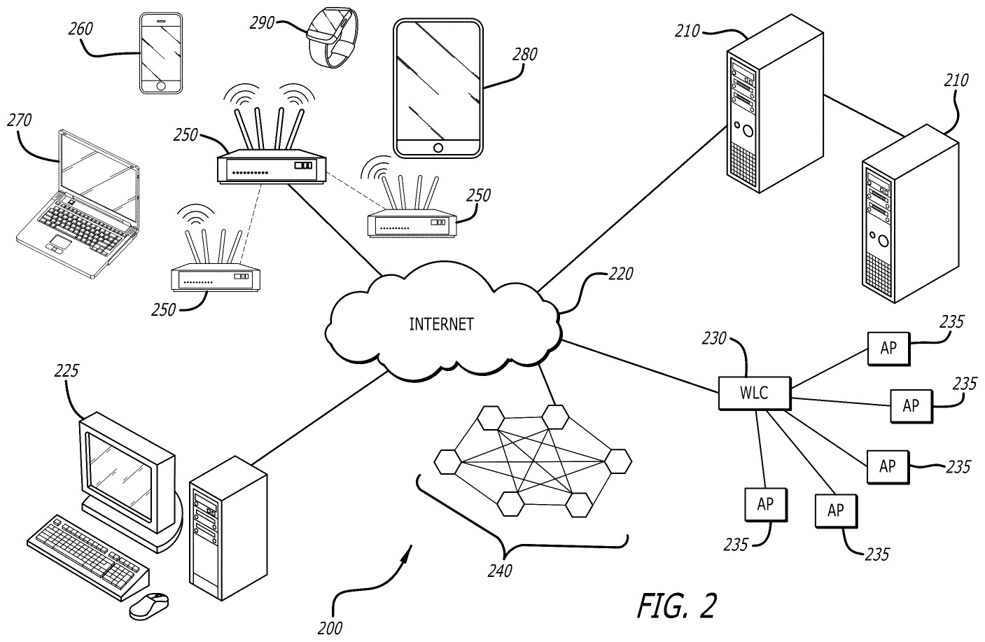

Although a specific embodiment for a wireless local area networking system 100 suitable for carrying out the various steps, processes, methods, and operations described herein is discussed with respect to FIG. 1, any of a variety of systems and/or processes may be utilized in accordance with embodiments of the disclosure. For example, the wireless local area networking system 100 may be configured into any number of various network topologies including different types of interconnected devices and user devices. The elements depicted in FIG. 1 may also be interchangeable with other elements of FIGS. 2-13 as required to realize a particularly desired embodiment.

Referring to FIG. 2, a conceptual network diagram 200 of various environments in which a communication logic may operate on a plurality of network devices in accordance with various embodiments of the disclosure is shown. Those skilled in the art will recognize that the communication logic can include various hardware and/or software deployments and can be configured in a variety of ways. In many embodiments, the communication logic can be configured as a standalone device, exist as a logic in another network device, be distributed among various network devices operating in tandem, or be remotely operated as part of a cloud-based network management tool. In a number of embodiments, one or more servers 210 can be configured with the communication logic or can otherwise operate as the communication logic. In a variety of embodiments, the communication logic may operate on one or more servers 210 connected to a communication network 220 (shown as the “Internet 220”). The communication network 220 can include wired networks or wireless networks. The communication logic can be provided as a cloud-based service that can service remote networks, such as, but not limited to a deployed network 240.

In various embodiments, the communication logic may be operated as a distributed logic across multiple network devices. In the embodiment depicted in FIG. 2, a plurality of network APs 250 can operate as the communication logic in a distributed manner or may have one specific device operate as the communication logic for all the neighboring or sibling APs 250. The APs 250 may facilitate Wi-Fi connections for various electronic devices, such as but not limited to, mobile computing devices including cellular phones 260, laptop computers 270, portable tablet computers 280, and wearable computing devices 290.

In more embodiments, the communication logic may be integrated within another network device. In the embodiment depicted in FIG. 2, a WLC 230 may have an integrated communication logic that the WLC 230 can utilize to monitor or control power consumption of a plurality of APs 235 to which the WLC 230 is connected, either by a wired connection or a wireless connection. In additional embodiments, a personal computer 225 may be utilized to access and/or manage various aspects of the communication logic, either remotely or within a network itself. In the embodiment depicted in FIG. 2, the personal computer 225 communicates over the communication network 220 and can access the communication logic of the servers 210, or the network APs 250, or the WLC 230.

Although a specific embodiment for various environments in which a communication logic may operate on a plurality of network devices suitable for carrying out the various steps, processes, methods, and operations described herein is discussed with respect to FIG. 2, any of a variety of systems and/or processes may be utilized in accordance with embodiments of the disclosure. For example, the communication logic may be provided as a device or a software separate from the WLC 230 or the communication logic may be integrated into the WLC 230. The elements depicted in FIG. 2 may also be interchangeable with other elements of FIG. 1 and FIGS. 3-13 as required to realize a particularly desired embodiment.

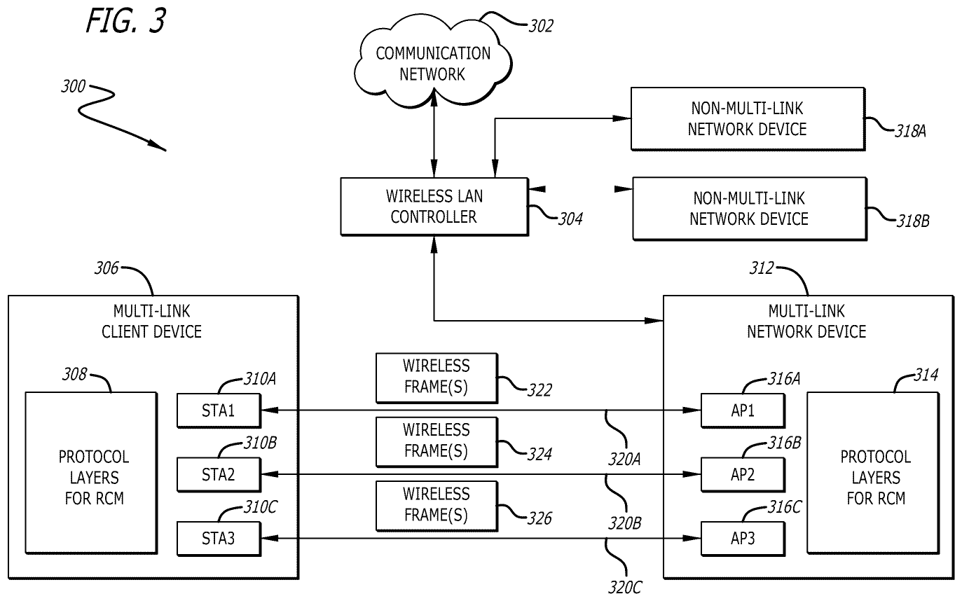

Referring to FIG. 3, a block diagram of a system 300 illustrating communication between multi-link devices and non-multi-link devices in accordance with various embodiments of the disclosure is shown. The Multi-Link Devices (MLDs) are distinguished from the non-MLDs or legacy devices also referred to as “single-link devices” that support only one wireless link. In many embodiments, the MLDs may implement wireless communication in compliance with the 802.11 protocol. For example, the 802.11 protocol may be the 802.11ax protocol, the 802.11be protocol, or a next-generation 802.11 protocol. In an exemplary implementation of the system 300, the MLDs may include a multi-link client device 306 and a multi-link network device 312. The multi-link client device 306 may refer to a client device capable of utilizing multiple wireless links, for example, the wireless links 320A, 320B, and 320C, herein collectively referred to as “links 320A-320C,” or frequency bands simultaneously to communicate with the multi-link network device 312. Each of the links 320A-320C may be provided in the same frequency band or in different frequency bands. The multi-link client device 306 may not operate as an AP and may also be referred to as a “non-AP Multi-Link Device (MLD).” Examples of the multi-link client device 306 may include any device including an end-user device such as a laptop, a tablet, a notebook, a smartphone, a gaming console, a dual-mode cellular phone, a wireless Voice-over-Internet Protocol (VOIP) phone, a mobile station, a personal digital assistant such as a converged device that supports WLAN data and/or voice, and cellular, a wearable device, other devices such as a printer, an Internet-of-Things (IoT) device, or a network infrastructure device such as a wireless mesh node, that can connect to a communication network 302. Further examples of the multi-link client device 306 may include a user terminal, a subscriber station, a subscriber unit, a user agent, or other devices that have a wireless communication function. The user terminal may include, for example, a handheld device, a vehicle-mounted device, a computing device that has the wireless communication function, or another processing device connected to a wireless modem, or any other suitable device configured to perform network communication via wireless media.

The multi-link client device 306 may include multiple STA instances, also referred to as “STAs,” for example, STA1 310A, STA2 310B, and STA3 310C, herein collectively referred to as “STAs 310A-310C.” The STAs 310A-310C may be configured to communicate with respective APs, for example, AP1 316A, AP2 316B, and AP3 316C, herein collectively referred to as “APs 316A-316C,” of the multi-link network device 312 using respective links 320A-320C. In a number of embodiments, an STA may refer to a logical representation of a station, for example, a laptop, a smartphone, or an IoT device, that connects to the communication network 302 via an AP. In a variety of embodiments, the STA may be a logical station or a physical station. The STAs 310A-310C may be logically separated but physically may share the same hardware or chipset. The STAs 310A-310C can operate independently and communicate with the respective APs 316A-316C. In various embodiments, each STA, for example, any of the STAs 310A 310C, within the multi-link client device 306 may include one or more radios, allowing the multi-link client device 306 to leverage a Multi-Link Operation (MLO). The MLO may allow the multi-link client device 306 to communicate over multiple links, for example, the links 320A-320C, or frequency bands simultaneously. In more embodiments, each STA, for example, any of the STAs 310A-310C, can operate on different radios or different frequency bands.

While a single STA, for example, STA1 310A, within the multi-link client device 306 can have more than one radio, the radios can operate on different frequency bands, for example, the 2.4 GHz band, the 5 GHz band, or the 6 GHz band. This allows STA1 310A to transmit and receive data on multiple links 320A-320C simultaneously, as part of the MLO, improving throughput, reliability, and overall performance. For example, STA1 310A within the multi-link client device 306 may utilize one radio on the 5 GHz band to handle high-throughput traffic and another radio on the 6 GHz band for tasks requiring lower latency such as online gaming or video conferencing. By utilizing multiple radios, the multi-link client device 306 can aggregate data streams across these radios to provide faster speeds and better coverage, while reducing congestion on any single frequency band, offering more stable and reliable connections.

In additional embodiments, the multi-link client device 306 may further include protocol layers 308 for Randomized and Changing MAC (RCM) that employs an RCM address, for example, an Identifiable Random MAC (IRM) address configured to be randomized for privacy of the multi-link client device 306 and still be identifiable by a communication network 302 to which the multi-link client device 306 connects. The protocol layers 308 for RCM may include, for example, the data link layer including the MAC sublayer, the network layer with the IP protocol, the physical layer, etc. Although shown separately, STA1 310A, STA2 310B, and STA3 310C may include or overlap with the protocol layers 308. The embodiments herein may configure the protocol layers 308 with multiple IP stacks and associate each IP stack to a distinct MLD MAC address, for example, one MLD MAC address per IP stack. In further embodiments, the IP stacks may utilize different types of IP, for example, one IP stack for IP version 4 (IPv4) and one IP stack for IP version 6 (IPv6), while in still more embodiments, the IP stacks may utilize the same IP type. The IP stack may refer to a logical entity of the network layer having an identity or a network address and other communication parameters that enable the IP stack to exchange frames or packets with a peer IP stack. The communication parameters may include a stack type such as IPv4, IPv6, or a networking protocol such as Internetwork Packet Exchange (IPX), and other optional elements such as a gateway address and one or more addresses of network service entities, for example, a Domain Name System (DNS) server. The configuration of the protocol layers 308 may allow the multi-link client device 306 to perform seamless RCM rotation in an MLD context using the IP stacks and their associated, distinct, MLD MAC addresses.

The multi-link client device 306 can simultaneously transmit and receive data across multiple frequency bands and channels, leveraging the MLO for enhanced performance and reliability. The MLO may simultaneously support multiple links 320A-320C with another MLO-capable device, for example, the multi-link network device 312. The multi-link client device 306 may connect to the multi-link network device 312 to gain access to the communication network 302. The MLO may allow the multi-link client device 306 connected to the multi-link network device 312, to simultaneously operate across multiple channels in different frequency bands including, for example, the 2.4 gigahertz (GHz) band, the 5 GHz band, and the 6 GHz band, and maintain simultaneous connections to the frequency bands on a single multi-link network device 312. In still further embodiments, the system 300 may also allow the multi-link client device 306 to roam between the multi-link network device 312 and non-multi-link network devices 318A and 318B. For example, the multi-link client device 306 may roam from the multi-link network device 312 to the non-multi-link network devices 318A or 318B, or from the non-multi-link network devices 318A or 318B to the multi-link network device 312. The multi-link network device 312 may operate as an AP capable of the MLO and may also be referred to as an “AP MLD”. The non-multi-link network devices 318A and 318B may also operate as APs, but without MLO capability, and may be referred to as “AP non-MLDs” or “non-MLO-capable APs.” For the sake of brevity and in a non-limiting example, the system 300 is shown in FIG. 3 to include only one reference multi-link client device 306, one multi-link network device 312, and two non-multi-link network devices 318A and 318B. However, in an actual implementation, the system 300 can include any number of reference multi-link client devices, multi-link network devices, and non-multi-link network devices spread across different geographical regions.

The multi-link network device 312 may refer to a networking device with MLO capability, that couples the multi-link client device 306 to the communication network 302. The multi-link network device 312 may allow the multi-link client device 306 to connect to the communication network 302 by utilizing, for example, Wi-Fix or other wireless technologies. The multi-link network device 312 may act as a bridge between the communication network 302 and the multi-link client device 306, enabling the multi-link client device 306 to access the communication network 302, share resources, and communicate with other devices, for example, the multi-link network devices 318A and 318B. The multi-link network device 312 may, for example, be an AP, a router, a base station, a gateway, a mesh system, a repeater, a server, a switch, a bridge, or the like.

The multi-link network device 312 may include multiple AP instances, also referred to as “APs,” for example, the APs 316A-316C. The APs 316A-316C may be configured to communicate with the respective STAs 310A-310C of the multi-link client device 306 using respective links 320A-320C. An AP may refer to a logical representation of an AP operating as part of an MLO within the multi-link network device 312. In still additional embodiments, the AP may refer to a virtual AP that may represent a specific radio or frequency band that is being utilized in a multi-link configuration. Each AP, for example, any of the APs 316A-316C, in a multi-link network device 312 may correspond to a different radio, where one AP such as AP1 316A may operate on the 2.4 GHz band and another AP such as AP2 316B may operate on the 5 GHz band within the same multi-link network device 312.

In some more embodiments, the multi-link network device 312 may further include protocol layers 314 for RCM. In yet various embodiments, the protocol layers 314 of the multi-link network device 312 may be peers to the protocol layers 308. To improve data throughput, in yet more embodiments, the multi-link client device 306 may communicate with the multi-link network device 312 concurrently over the links 320A-320C. For example, STA1 310A of the multi-link client device 306 may communicate with AP1 316A of the multi-link network device 312 over a first link 320A in the 2.4 GHz band, STA2 310B of the multi-link client device 306 may communicate with AP2 316B of the multi-link network device 312 over a second link 320B in the 5 GHz band, and STA3 310C of the multi-link client device 306 may communicate with AP3 316C of the multi-link network device 312 over a third link 320C in the 6 GHz band. In still yet more embodiments, STA2 310B of the multi-link client device 306 may communicate with AP2 316B of the multi-link network device 312 over the second link 320B potentially concurrently with the communication via the first link 320A. In many further embodiments, STA3 310C of the multi-link client device 306 may communicate with AP3 316C of the multi-link network device 312 over the third link 320C potentially concurrently with the communication via the first link 320A or the second link 320B. The STAs 310A-310C of the multi-link client device 306 may transmit respective wireless frames, for example, wireless frames 322, 324, and 326, to the respective APs 316A-316C via the respective links 320A-320C across multiple frequency bands and channels, leveraging the MLO. The STAs 310A-310C may be implemented through one or more radios.

In many additional embodiments, the multi-link network device 312 and the non-multi-link network devices 318A and 318B may be communicatively coupled to a communication network 302 via a wireless LAN controller 304. The communication network 302 utilized for connections and communications between various devices of the system 300 may include, for example, the internet, satellite internet, an intranet, a wireless network, a communication network that implements Bluetooth® of Bluetooth Sig, Inc., a Wi-Fi network, an Ultra-WideBand (UWB) communication network, a wireless Universal Serial Bus (USB) communication network, a communication network that implements ZigBee® of ZigBee Alliance Corporation, a General Packet Radio Service (GPRS) network, a mobile telecommunication network such as a Global System for Mobile (GSM) communications network, a Code Division Multiple Access (CDMA) network, an Nth generation mobile communication network, where “N” may be 2, 3, 4, 5, 6, etc., a Long-Term Evolution (LTE) mobile communication network, a public telephone network, etc., a Local Area Network (LAN), a Wide Area Network (WAN), an infrared communication network, etc., or a network formed from any combination of these networks.

In still yet further embodiments, the wireless LAN controller 304 may be a computing device configured to manage and control actions of one or more network devices, for example, the multi-link network device 312 and the non-multi-link network devices 318A and 318B in the WLAN. In still yet additional embodiments, the RCM capabilities of the multi-link network device 312 and the non-multi-link network devices 318A and 318B, with respect to the multi-link client device 306 can be offloaded to the wireless LAN controller 304. Although the wireless LAN controller 304 is shown as a single computing device in FIG. 3, the wireless LAN controller 304 may represent multiple different computing devices either physically located near the multi-link network device 312 and the non-multi-link network devices 318A and 318B, or physically separate and accessed through the communication network 302.

The embodiments illustrated in FIG. 3 are described in the context of providing MAC address randomization support for MLDs, for example, the multi-link client device 306 and the multi-link network device 312. In several embodiments, the multi-link client device 306 may transmit an IRM address of the multi-link client device 306 to the multi-link network device 312, for example, in Message 4 of a four-way handshake, using an IRM Key Delivery Element (KDE) of a wireless frame. The multi-link network device 312 may utilize this IRM address to recognize the multi-link client device 306, for example, in a subsequent association or in pre-association messaging such as a probe request. The multi-link client device 306 may then generate one or more wireless frames 322, 324, and/or 326 indicating the IRM address as a physical address. The wireless frame(s) 322, 324, and/or 326 may correspond, for example, to one of: action frame, a public action frame, a probe request frame, a multi-link probe request frame, an access network query protocol (ANQP) frame, a pre-association request frame, an authentication frame, an association request frame, or a reassociation request frame.

The IRM address in each wireless frame may identify at least one of the affiliated STAs, for example, the STAs 310A-310C, of the multi-link client device 306. The multi-link client device 306 may then transmit the wireless frame(s) 322, 324, and/or 326 to the multi-link network device 312. In several more embodiments, the multi-link client device 306 may sequentially transmit the wireless frame(s) 322, 324, and/or 326 via the STAs 310A-310C. In numerous embodiments, the multi-link client device 306 may simultaneously transmit the wireless frame(s) 322, 324, and/or 326 via the STAs 310A-310C. In numerous additional embodiments where the multi-link client device 306 includes multiple radios, the multi-link client device 306 may sequentially utilize the IRM address as the physical address across the STAs 310A-310C for the transmission of the wireless frame(s) 322, 324, and/or 326.

In further additional embodiments, the IRM address may be indicated as the physical address in a Transmitter Address (TA) field of the wireless frame(s) 322, 324, and/or 326. In many embodiments, the multi-link client device 306 including a single radio may utilize the same IRM address as a transmitter address when scanning across multiple frequency bands. In a number of embodiments, the multi-link client device 306 including multiple radios for different frequency bands, for example, one radio associated with STA1 310A for the 2.4 GHz band, another radio associated with STA2 310B for the 5 GHz band, and another radio associated with STA3 310C for the 6 GHz band. The multi-link client device 306 may perform scanning using only one radio at a time and may utilize the IRM address as the transmitter address on that radio operating, for example, at 2.4 GHz. The multi-link client device 306 may then pass the IRM address to the other radio operating, for example, at 5 GHz or 6 GHz, and may utilize the same IRM address to scan on the other frequency bands such as the 5 GHz or 6 GHz bands. In this manner, in every probe request frame transmitted for active scanning, the respective APs 316A-316C can recognize the respective STAs 310A-310C because a recognized IRM address is utilized.

In a variety of embodiments, the multi-link client device 306 can perform scanning in parallel by utilizing multiple radios. In these embodiments, only one of the radios may utilize the IRM address as the transmitter address when scanning. Each of the other radios may utilize a different IRM address which may not be recognized by the multi-link network device 312. This approach may only allow the multi-link network device 312 to recognize the IRM address of one of the STAs 310A-310C of the multi-link client device 306, for example, in a pre-association scan. In various embodiments, the multi-link client device 306 may utilize the same IRM address as the transmitter address for its pre-association traffic on multiple radios. The STAs 310A-310C of this multi-link client device 306 may, therefore, appear as a single MAC address over multiple frequency bands to the multi-link network device 312. As the STAs 310A-310C are on the same multi-link network device 312, the duplication of the MAC address is a non-issue. In more embodiments, both a single-radio or multi-radio, multi-link client device 306 may utilize the IRM address, which is recognized by the multi-link network device 312, as the transmitter address from one of the radios to transmit a multi-link probe request frame to one of the APs 316A-316C affiliated with the multi-link network device 312. In additional embodiments, when the multi-radio, multi-link client device 306 transmits a subsequent association request frame or a reassociation request frame on one of the links 320A-320C between the multi-link client device 306 and the multi-link network device 312, the multi-link client device 306 may utilize the IRM address as the transmitter address in either request frame, regardless of the link, for example, any of the links 320A-320C, on which either request frame is transmitted.

In further embodiments, the IRM address may be indicated as the physical address in an MLD MAC address field of the wireless frame(s) 322, 324, and/or 326. In still more embodiments, the MLD MAC address field may be included in a multi-link element of the wireless frame(s) 322, 324, and/or 326. In still further embodiments, the multi-link element may correspond to one of a basic multi-link element or a probe request multi-link element. In still additional embodiments, the multi-link client device 306 may transmit the wireless frame(s) 322, 324, and/or 326 for one of an MLO or a non-MLO. In some more embodiments, based on the transmission of the wireless frame(s) 322, 324, and/or 326 for the MLO, the IRM address may be indicated as the physical address in an MLD MAC address field of the wireless frame(s) 322, 324, and/or 326.

In yet various embodiments, the multi-link client device 306 may transmit, for the non-MLO, a new wireless frame indicating the IRM address in a TA field of the new wireless frame. In yet more embodiments, based on the transmission of the wireless frame(s) 322, 324, and/or 326 for the non-MLO, the IRM address may be indicated as the physical address in a TA field of the wireless frame(s) 322, 324, and/or 326. In still yet more embodiments, the multi-link client device 306 may transmit, for the MLO, a new wireless frame indicating the IRM address in an MLD MAC address field of the new wireless frame.

In many further embodiments, the multi-link network device 312 may receive and store a first IRM address of the multi-link client device 306. The multi-link network device 312 may then receive at least one of the wireless frames 322, 324, and 326 indicating a second IRM address as a physical address. The multi-link network device 312 may receive at least one of the wireless frames 322, 324, and 326 for an MLO or a non-MLO. The multi-link network device 312 may recognize at least one of the STAs 310A-310C of the multi-link client device 306 based on a match of the second IRM address with the first IRM address.

Although a specific embodiment for a system 300 illustrating communication between multi-link devices and non-multi-link devices suitable for carrying out the various steps, processes, methods, and operations described herein is discussed with respect to FIG. 3, any of a variety of systems and/or processes may be utilized in accordance with embodiments of the disclosure. For example, the system 300 may be configured into any number of various network topologies including different types of interconnected MLDs, non-MLDs, client devices, and network devices spread across different locations, while providing MAC address randomization support for the MLDs. The elements depicted in FIG. 3 may also be interchangeable with other elements of FIGS. 1-2 and FIGS. 4-13 as required to realize a particularly desired embodiment.

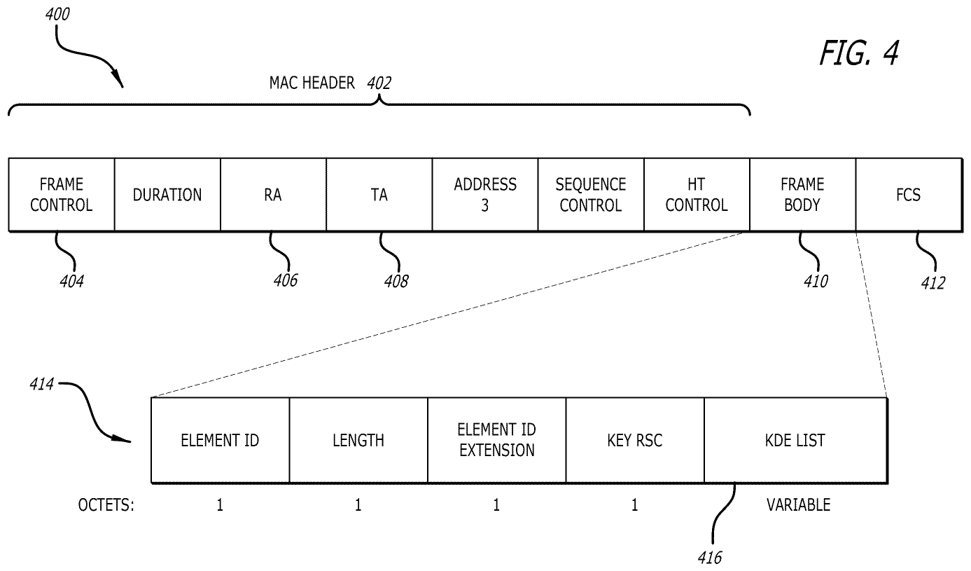

Referring to FIG. 4, a schematic illustration of a format of a wireless frame 400 including a key delivery element 414 for transmitting one or more IRM addresses in accordance with various embodiments of the disclosure is shown. By way of a non-limiting example, the embodiments shown in FIG. 4 illustrate the format of the wireless frame 400 for transmitting one or more IRM addresses of a multi-link client device to a network device, for example, an AP MLD, to prevent third parties from tracking the multi-link client device while still allowing trusted parties such as the network device to identify the multi-link client device. In many embodiments, the wireless frame 400 may correspond to one of: an action frame, a public action frame, a probe request frame, a multi-link probe request frame, an ANQP frame, a pre-association request frame, an authentication frame, an association request frame, or a reassociation request frame.

In a number of embodiments, the wireless frame 400 may include a MAC header 402, a variable length frame body 410, and a Frame Check Sum (FCS) field 412. The FCS field 412 may be utilized to detect one or more errors in the wireless frame 400. The MAC header 402 may include, for example, a frame control field 404, a duration field, address fields such as a Receiver Address (RA) field 406, a Transmitter Address (TA) field 408, an address 3 field, an optional sequence control information field, and an optional High Throughput (HT) control field. The frame control field 404 may include a type field and a subtype field, configured to define the function of the wireless frame 400. For example, the frame control field 404 including type 00 and subtype 0000, defines an association request frame. In a further example, the frame control field 404 including type 00 and subtype 0010, defines a reassociation request frame. In a still further example, the frame control field 404 including type 00 and subtype 0100, defines a probe request frame. In an additional example, the frame control field 404 including type 00 and subtype 1101, defines an action frame.

In the MAC header 402, the RA field 406 may indicate an address of an intended receiver of the wireless frame 400 and the TA field 408 may indicate an address of a transmitter of the wireless frame 400. Each address field may contain a 48-bit address known as the MAC address. For enhanced privacy, the multi-link client device may periodically change its MAC address prior to association with the network device. The multi-link client device may generate a wireless frame 400 of the format shown in FIG. 4 and indicate the IRM address as a physical address in the wireless frame 400. The IRM address in the wireless frame 400 may identify at least one affiliated STA of the multi-link client device. In a variety of embodiments, the IRM address may be indicated as the physical address in the TA field 408 of the MAC header 402 of the wireless frame 400.

Further, by way of a non-limiting example, the embodiments shown in FIG. 4 illustrate the format of the KDE 414 for transmitting one or more IRM addresses of the multi-link client device to the network device. In various embodiments, the KDE 414 may be included in the frame body 410 of the wireless frame 400. The frame body 410 may include the actual data or payload of the wireless frame 400 that needs to be delivered to the network device. In more embodiments, the KDE 414 may include multiple fields including, for example, an element identifier (ID) field, a length field, an element ID extension field, a key Receiver Sequence Counter (RSC) field, and a Key Data Encapsulation (KDE) list field. The element ID field or the element ID extension field may indicate a type of an element including an element ID or an element ID extension. For example, the element ID field or the element ID extension field may indicate whether the element corresponds to a KDE. The length field may indicate the length of the KDE 414 including the length field. The key RSC field may include a receive sequence counter for a Group Temporal Key (GTK) being installed to the same link on which the KDE 414 is transmitted. The KDE list field 416 may include one or more KDEs encapsulated using a predefined format. For example, the KDE list field 416 may include a GTK KDE, an Individual GTK (IGTK) KDE, and a Broadcast IGTK (BIGTK) KDE for the same link on which the KDE 414 is transmitted. In a further example, the KDE list field 416 may include a multi-link GTK KDE, a multi-link IGTK KDE, and a multi-link BIGTK KDE for different links on which the KDE 414 is transmitted. In additional embodiments, each different IRM address may be transmitted in a different KDE 414. In further embodiments, multiple IRM addresses may be provided in the KDE list field 416 of a single KDE 414. These multiple IRM addresses may be provided in a list of concatenated fields in the same KDE 414. In still more embodiments, the IRM addresses may be included in multiple subfields of the KDE list field 416. In still further embodiments, each IRM address may be tagged with a frequency band and a MAC address.

In still additional embodiments, similar to an STA in the case of a non-MLO, the multi-link client device may provide a single IRM address to the network device, for example, in Message 4 of a four-way handshake, using the KDE 414 illustrated in FIG. 4. The network device may utilize this single IRM address to recognize the multi-link client device in a subsequent association or in pre-association messaging such as a probe request. In the case of the MLO, in some more embodiments, the multi-link client device may include a single radio and may perform active scanning, for example, by transmitting the wireless frame 400 configured as a probe request frame, using the same radio across multiple frequency bands, for example, the 2.4 GHz band, the 5 GHz band, and the 6 GHz band, one by one. In this case, the single-radio, multi-link client device may utilize the same IRM address as a transmitter address in the TA field 408 of each wireless frame 400 when scanning across multiple frequency bands. In yet various embodiments, the multi-link client device may include multiple radios for different bands, for example, one radio for the 2.4 GHz band and another radio for the 5 GHz band or the 6 GHz band. For a multi-radio, multi-link client device that cannot perform scanning using the same radio on all frequency bands, in yet more embodiments, the multi-radio, multi-link client device may perform scanning by utilizing only one radio at a time and by utilizing the IRM address as the transmitter address in the TA field 408 of the wireless frame on that radio operating, for example, at 2.4 GHz. The multi-radio, multi-link client device may then pass the IRM address to the other radio operating, for example, at 5 GHz or 6 GHz, and utilize the same IRM address to perform scanning on the other frequency bands, for example, the 5 GHz band or the 6 GHz band, thereby allowing the network device to recognize an STA of the multi-radio, multi-link client device because a recognized IRM address is utilized in every probe request frame transmitted for active scanning.

In still yet more embodiments, the multi-radio, multi-link client device can perform scanning in parallel by utilizing multiple radios. In these embodiments, only one of the radios may utilize the IRM address as the transmitter address in the TA field 408 of each wireless frame 400 when scanning. Each of the other radios may utilize a different IRM address which may not be recognized by the network device. This approach may only allow the network address to recognize the IRM address of one of the STAs of the multi-radio, multi-link client device in a pre-association scan. In many further embodiments, the multi-radio, multi-link client device may utilize the same IRM address as the transmitter address in the TA field 408 of each wireless frame 400 for its pre-association traffic on multiple radios. The STAs of this multi-radio, multi-link client device may, therefore, appear as a single MAC address over multiple frequency bands to the network device. As the STAs are on the same multi-radio, multi-link client device, the duplication of the MAC address is a non-issue. In many additional embodiments, both a single-radio, multi-link client device or a multi-radio, multi-link client device may utilize the IRM address, which is recognized by the network device, as the transmitter address in the TA field 408 of the wireless frame 400 from one of the radios to transmit a multi-link probe request frame to one of the APs affiliated with the network device.

In still yet further embodiments, when the multi-radio, multi-link client device, transmits a subsequent wireless frame 400 configured as an association request frame or a reassociation request frame on one of the wireless links between the multi-radio, multi-link client device and the network device, the multi-radio, multi-link client device may utilize the IRM address as the transmitter address in the TA field 408 of either wireless frame 400, regardless of the wireless link on which either wireless frame 400 is transmitted. The association request frame or the reassociation request frame may herein be referred to as the “(re)association request frame.” In still yet additional embodiments, the IRM address may be utilized as the transmitter address in the TA field 408 in the (re)association request frame, whichever wireless frame 400 is transmitted by the multi-radio, multi-link client device, such that the network device can recognize the multi-radio, multi-link client device from the previous association.

In several embodiments, the multi-link client device may provide multiple, link level IRM addresses, one for each radio or frequency band supported by the multi-link client device. In an example scenario, as part of an initial association within an ESS, the multi-link client device may transmit multiple IRM addresses in one or more IRM KDEs 414, one IRM address for each of its supported radios or frequency bands in Message 4 of the four-way handshake with the network device. The network device may receive and store the transmitted IRM addresses for that multi-link client device. Subsequently, when the multi-link client device performs a pre-association scan by utilizing its multiple radios in parallel, the multi-link client device may utilize each of the IRM addresses as the transmitter address in the TA field 408 of a wireless frame 400 for recognition by the network device. The network device may utilize each of the IRM addresses to recognize the multi-link client device. In several more embodiments, for a subsequent association, the multi-link client device may utilize one of the IRM addresses previously provided to the network device as the transmitter address in the TA field 408 of a (re)association request frame on one of the wireless links established with the network device, allowing the network device to recognize the multi-link client device from the previous association. In numerous embodiments, the multi-link client device may also utilize the IRM address in the TA field 408 of the wireless frame(s) 400, when the multi-link client device transitions from an MLO association to a non-MLO association and vice versa. In numerous additional embodiments, the multi-link client device may signal the IRM address in the TA field 408 of the wireless frame(s) 400 between MLO and non-MLO transitions.

Although a specific embodiment for a format of a wireless frame 400 including a KDE for transmitting one or more IRM addresses suitable for carrying out the various steps, processes, methods, and operations described herein is discussed with respect to FIG. 4, any of a variety of systems and/or processes may be utilized in accordance with embodiments of the disclosure. For example, other formats for the KDE in the wireless frame 400 can be utilized to convey one or more IRM addresses to the network device. Further, additional KDEs may be utilized for conveying multiple link level IRM addresses to the network device. The elements depicted in FIG. 4 may also be interchangeable with other elements of FIGS. 1-3 and FIGS. 5-13 as required to realize a particularly desired embodiment.

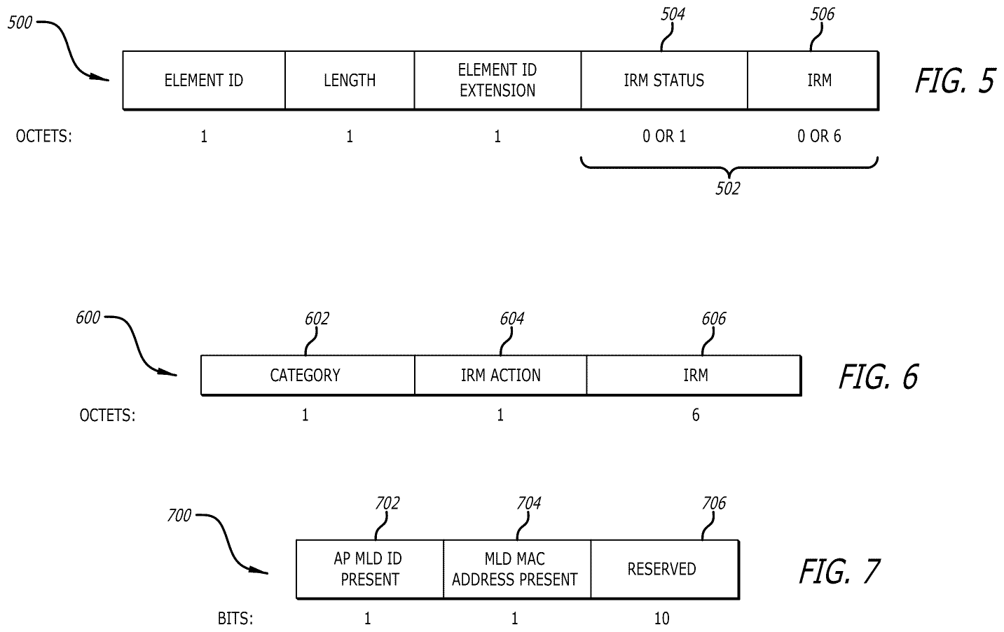

Referring to FIG. 5, a schematic illustration of a format of an IRM element 500 for transmitting one or more IRM addresses in accordance with various embodiments of the disclosure is shown. In many embodiments, the IRM element 500 may be included in a frame body of a wireless frame. In a number of embodiments, the IRM element 500 may include multiple fields including, for example, an element identifier (ID) field, a length field, an element ID extension field, an IRM status field 504, and a IRM field 506. The element ID field or the element ID extension field may indicate a type of an element including an element ID or an element ID extension. For example, the element ID field or the element ID extension field may indicate whether the element corresponds to an IRM element. The length field may indicate the length of the IRM element 500 including the length field. The IRM status field 504 and the IRM field 506 may constitute an IRM KDE format 502. A multi-link client device, for example, a non-AP MLD, may transmit a wireless frame containing the IRM address of the multi-link client device in the IRM field 506 of the IRM element 500 to a network device, for example, an AP MLD, to identify the multi-link client device. In a variety of embodiments, the IRM field 506 may not be present in the IRM element 500 when a corresponding wireless frame is transmitted from the network device to the multi-link client device. In various embodiments, when the wireless frame including the IRM element 500 is transmitted to the network device, the IRM status field 504 may not be present in the IRM element 500. The IRM status field 504 may be present in the IRM element 500 of the wireless frame transmitted from the network device to the multi-link client device. The IRM status field 504 may indicate whether the multi-link client device is recognized by the network device. In an example, when transmitted from the network device to the multi-link client device, the IRM status field 504 may include a value of “0” indicating that the IRM address and in turn the multi-link client device has been recognized, and may include a value of “1” indicating that the IRM address and in turn the multi-link client device has not been recognized.

Although a specific embodiment for a format of an IRM element 500 for transmitting one or more IRM addresses suitable for carrying out the various steps, processes, methods, and operations described herein is discussed with respect to FIG. 5, any of a variety of systems and/or processes may be utilized in accordance with embodiments of the disclosure. For example, other formats for the IRM element 500 in the wireless frame can be utilized to convey one or more IRM addresses to the network device. Further, additional IRM elements may be utilized for conveying multiple link level IRM addresses to the network device. The elements depicted in FIG. 5 may also be interchangeable with other elements of FIGS. 1-4 and FIGS. 6-13 as required to realize a particularly desired embodiment.

Referring to FIG. 6, a schematic illustration of a format of an IRM frame action field 600 for transmitting one or more IRM addresses in accordance with various embodiments of the disclosure is shown. The IRM frame action field 600 may be included in a frame body of a wireless frame configured as an action frame for transmitting one or more IRM addresses. In many embodiments, the action frame may be extended to support multiple IRM addresses, one for each radio or frequency band supported by a multi-link client device. In a number of embodiments, the IRM frame action field 600 may include a category field 602, an IRM action field 604, and an IRM field 606. The category field 602 may indicate a type of action or a purpose of the action, for example, association, reassociation, or the like being performed. A single octet IRM action field 604 may follow immediately after the category field 602. The multi-link client device, for example, a non-AP MLD, may transmit a wireless frame containing the IRM address of the multi-link client device in the IRM field 606 of the IRM frame action field 600 to a network device, for example, an AP MLD, to identify the multi-link client device. In a variety of embodiments, a value of “0” in the IRM action field 604 of the IRM frame action field 600 may indicate a duplicate IRM address and a value of “1” in the IRM action field 604 may indicate a new IRM address.

Although a specific embodiment for a format of an IRM frame action field 600 for transmitting one or more IRM addresses suitable for carrying out the various steps, processes, methods, and operations described herein is discussed with respect to FIG. 6, any of a variety of systems and/or processes may be utilized in accordance with embodiments of the disclosure. For example, other formats for the IRM frame action field 600 in the wireless frame can be utilized to convey one or more IRM addresses or multiple link level IRM addresses to the network device. The elements depicted in FIG. 6 may also be interchangeable with other elements of FIGS. 1-5 and FIGS. 7-13 as required to realize a particularly desired embodiment.

Referring to FIG. 7, a schematic illustration of a format of a presence bitmap field 700 of a probe request multi-link element in accordance with various embodiments of the disclosure is shown. The probe request multi-link element may be utilized to request a network device, for example, an AP MLD, to provide information of the APs affiliated with the AP MLD. The inclusion of the probe request multi-link element in a wireless frame configured as a probe request frame may identify the probe request frame as a multi-link probe request. In many embodiments, the presence bitmap field 700 of the probe request multi-link element may include an AP MLD ID present subfield 702, an MLD MAC address present subfield 704, and a reserved subfield 706. In number of embodiments, the AP MLD ID present subfield 702 may be set to a value of “1” if the AP MLD ID subfield is present in a common information field of the probe request multi-link element. If the AP MLD ID subfield is absent in the common information field of the probe request multi-link element, the AP MLD ID present subfield 702 may be set to a value of “0”. The MLD MAC address present subfield 704 may be configured to indicate the presence of an MLD MAC address in the probe request multi-link element. In a variety of embodiments, the MLD MAC address present subfield 704 may be set to a value of “1” if an MLD MAC address field is present in the common information field of the probe request multi-link element. If the MLD MAC address field is absent in the common information field of the probe request multi-link element, the MLD MAC address present subfield 704 may be set to a value of “0.” The reserved subfield 706 may include one or more reserved or unused bits.

Although a specific embodiment for a format of a presence bitmap field 700 of a probe request multi-link element suitable for carrying out the various steps, processes, methods, and operations described herein is discussed with respect to FIG. 7, any of a variety of systems and/or processes may be utilized in accordance with embodiments of the disclosure. For example, other formats for the presence bitmap field 700 in the wireless frame can be utilized to convey the presence of one or more MLD MAC addresses in the probe request multi-link element. The elements depicted in FIG. 7 may also be interchangeable with other elements of FIGS. 1-6 and FIGS. 8-13 as required to realize a particularly desired embodiment.

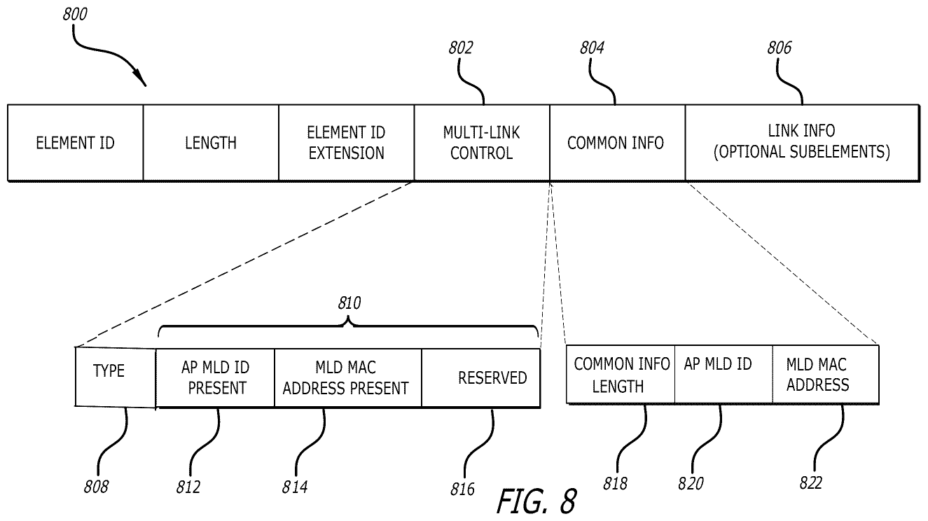

Referring to FIG. 8, a schematic illustration of a multi-link element 800 including a multi-link control field 802 and a common information field 804 in accordance with various embodiments of the disclosure is shown. A multi-link discovery, setup, and operation may be performed on the basis of a wireless frame including the multi-link element 800. For example, the multi-link element 800 may be included in an action frame, a public action frame, a probe request frame, a multi-link probe request frame, an ANQP frame, a pre-association request frame, an authentication frame, an association request frame, or a reassociation request frame, or the like. In many embodiments, the multi-link element 800 may include an element ID field, a length field, an element ID extension field, a multi-link control field 802, a common information (info) field 804, and a link information (info) field 806 with optional sub-elements. The element ID field or the element ID extension field may indicate a type of an element including an element ID or an element ID extension. For example, the element ID field or the element ID extension field may indicate whether the element corresponds to a multi-link element. The length field may indicate the length of the multi-link element 800 including the length field. The link info field 806 may include information on each of multiple links established between a multi-link client device herein referred to as an “non-AP MLD”, and a network device herein referred to as an “AP MLD”.

In a number of embodiments, the multi-link control field 802 may include a type field 808 and a presence bitmap field 810. The type field 808 may be utilized to differentiate between variants of the multi-link element 800. For example, the type field 808 may indicate whether the multi-link element 800 is a basic multi-link element or a probe request multi-link element. The presence bitmap field 810 may indicate whether a subfield which can be included in the multi-link element 800 is included. For example, the presence bitmap field 810 may indicate whether a subfield which can be included in the common info field 804 is included. In a variety of embodiments, the presence bitmap field 810 may include an AP MLD ID present subfield 812, an MLD MAC address present subfield 814, and a reserved subfield 816. In various embodiments, the AP MLD ID present subfield 812 may be set to a value of “1” if an AP MLD ID subfield 820 is present in the common info field 804 of the multi-link element 800. If the AP MLD ID subfield 820 is absent in the common info field 804 of the multi-link element 800, the AP MLD ID present subfield 812 may be set to a value of “0”. The MLD MAC address present subfield 814 may be configured to indicate the presence of an MLD MAC address in the multi-link element 800. In more embodiments, the MLD MAC address present subfield 814 may be set to a value of “1” if an MLD MAC address field 822 is present in the common info field 804 of the multi-link element 800. If the MLD MAC address field 822 is absent in the common info field 804 of the multi-link element 800, the MLD MAC address present subfield 814 may be set to a value of “0.” The reserved subfield 816 may include one or more reserved or unused bits. The common info field 804 may include a common info length subfield 818, an AP MLD ID subfield 820, and an MLD MAC address field 822. The common info length subfield 818 may indicate the length of the common info field 804 including the common info length subfield 818. The AP MLD ID subfield 820 may indicate an identifier of the AP MLD. In additional embodiments, the MLD MAC address field 822 may be set to an IRM address, when the non-AP MLD transmits a multi-link probe request frame to the AP MLD for recognition by the AP MLD.

In further embodiments, an affiliated STA of the non-AP MLD, when transmitting the multi-link probe request frame, may provide the IRM address in the MLD MAC address field 822 of the multi-link element 800 configured as a basic multi-link element. In still more embodiments, the affiliated STA of the non-AP MLD may include the basic multi-link element only in the multi-link probe request frame, which is an MLO-specific pre-association frame. In still further embodiments, the affiliated STA of the non-AP MLD may include the basic multi-link element only if both the non-AP MLD and the AP MLD have declared support for the IRM mechanism.

In still additional embodiments, an affiliated STA of the non-AP MLD may provide the IRM address in the MLD MAC address field 822 of the multi-link element 800 configured as a probe request multi-link element. In some more embodiments, the probe request multi-link element can be enhanced to include the MLD MAC address of an originator non-AP MLD which can then be set to the IRM address provided by the non-AP MLD in the previous multi-link setup, to provide the IRM address to the AP MLD. In these embodiments, the MLD MAC address present subfield 814 in the presence bitmap field 810 may indicate a presence of a non-AP MLD MAC address in the probe request multi-link element. In yet various embodiments, the MLD MAC address present subfield 814 may be set to a value of “1” only when the IRM mechanism is activated and the AP MLD has indicated support for the IRM mechanism. When the MLD MAC address present subfield 814 is set to the value of “1”, the non-AP MLD may include the IRM address as the non-AP MLD MAC address in the MLD MAC address field 822 of the common info field 804 of the probe request multi-link element. The AP MLD can then utilize the IRM address to recognize the non-AP MLD.

In yet more embodiments, a non-AP MLD that previously provided an IRM address to an AP MLD in an ESS and later associates with an AP within the same ESS, may provide that IRM address as the MAC address in a TA field in authentication and (re)association request frames if the non-AP MLD intends to be identified by the AP in that ESS. In still yet more embodiments, when the non-AP MLD later performs another multi-link setup with an AP MLD in the same ESS, where the non-AP MLD provided the IRM address in the last multi-link association, the non-AP MLD may set the IRM address in the MLD MAC address field 822 in the basic multi-link element of the authentication and (re)association request frames. In many further embodiments, the non-AP MLD can also set the same IRM address in the TA field of the authentication and (re)association request frames, since the 802.11be draft amendment allows the STA MAC address and the MLD MAC address to be the same. In many additional embodiments, when transmitting MLD level frames to another AP MLD including a multi-link probe request frame, an authentication request frame, and an association request frame, the non-AP MLD may set the MLD MAC address field 822 in the basic multi-link element of each of the frames to the provided IRM address when the non-AP MLD intends to be identified.

In still yet further embodiments, an affiliated STA of a non-AP MLD may associate with a non-MLO AP and provide an IRM address that identifies the non-AP MLD during a four-way handshake. When the same affiliated STA of the same non-AP MLD later establishes a multi-link association with an AP MLD in the same ESS, using the multi-link setup, the non-AP MLD may utilize the MAC address of the affiliated STA as the MLD MAC address, in accordance with the 802.11be amendment. Hence, the MLD MAC address field 822 in the basic multi-link element in an authentication request frame and a (re)association request frame for the multi-link setup can be set to the IRM address that was previously provided during the non-multi-link association with the non-MLO AP. In still yet additional embodiments, the transmitter address in the authentication request frame and the (re)association request frame can also be set to the IRM address, since the IRM address may also correspond to the MAC address of the affiliated STA. Similarly, in several embodiments, in any multi-link-specific pre-association frame, for example, a multi-link probe request frame, the MAC address of the non-AP MLD either in a probe request multi-link element or a basic multi-link element can be set to the IRM address that was previously provided by the non-AP MLD to the non-MLO AP in the same ESS.

In several more embodiments, an affiliated STA of a non-AP MLD that previously provided an IRM address to an AP in an ESS and later associates with an AP MLD within the same ESS, may provide that IRM address in the MLD MAC address field 822 in the basic multi-link element of the multi-link probe request frame, the authentication request frame, and the (re)association request frame if the affiliated STA intends to be identified by the AP MLD in that ESS. In numerous embodiments, the non-AP MLD may set the IRM address provided previously both in the TA field and in the MLD MAC address field 822 of the basic multi-link element in the pre-association frames such as the multi-link probe request frame, the authentication request frame, and the (re)association request frame. For any non-MLO pre-association frame, for example, a non-multi-link probe request frame or an ANQP frame, the TA field of the non-MLO pre-association frame may be set to the IRM address, independent of whether the IRM address was provided as part of an MLO association or a non-MLO association, which may optimize the logic of the multi-link client device. This may also optimize the logic of the AP, since if the non-AP MLD sets both the TA field and the MLD MAC address field 822 to the IRM address, then the AP may merely inspect the TA field to find the IRM address to recognize the affiliated STA of the non-AP MLD.

Although a specific embodiment for a multi-link element 800 including a multi-link control field 802 and a common information field 804 of a suitable for carrying out the various steps, processes, methods, and operations described herein is discussed with respect to FIG. 8, any of a variety of systems and/or processes may be utilized in accordance with embodiments of the disclosure. For example, other formats for the multi-link element 800 in the wireless frame can be utilized to convey one or more IRM addresses in the MLD MAC address field 822 of the common info field 804. The elements depicted in FIG. 8 may also be interchangeable with other elements of FIGS. 1-7 and FIGS. 9-13 as required to realize a particularly desired embodiment.

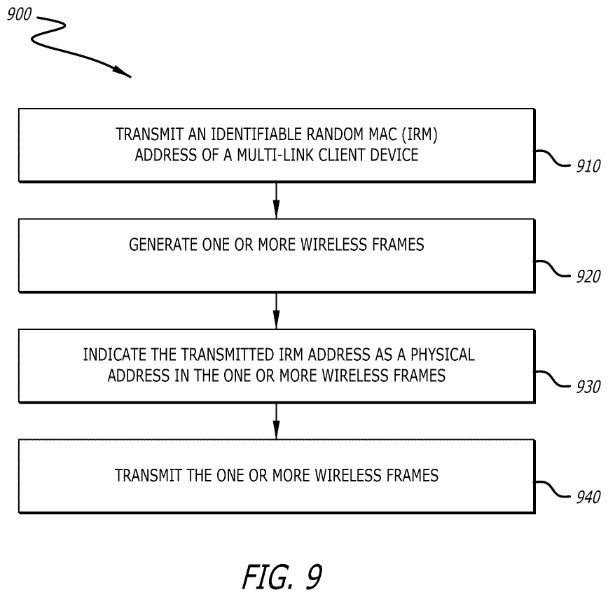

Referring to FIG. 9, a flowchart depicting a process 900 for providing MAC address randomization support for a multi-link client device in accordance with various embodiments of the disclosure is shown. In many embodiments, the process 900 may transmit an Identifiable Random MAC (IRM) address of a multi-link client device (block 910). The process 900 may transmit the IRM address from the multi-link client device. The IRM address may be configured to identify the multi-link client device each time the multi-link client device connects to a network via a network device. The network may be a WLAN, for example, a Wi-Fi network. The IRM address may be configured to be both randomized for privacy of the multi-link client device and still be identifiable by the network to which the multi-link client device connects. In a number of embodiments, the multi-link client device, for example, a tablet, a smartphone, a laptop, an IoT device, or the like, may be a non-AP MLD that does not operate as an AP. In a variety of embodiments, the multi-link client device may incorporate one or more radios, with each radio operating on a different frequency band or channel and maintaining communications with a corresponding radio on the network device that operates in that frequency band. The process 900 may transmit the IRM address in an IRM KDE element of a wireless frame. For example, the process 900 may transmit a single IRM address in Message 4 of a four-way handshake with the network device, by utilizing the IRM KDE of the wireless frame. The network device may utilize this single IRM address to recognize the multi-link client device, for example, in a subsequent association or in pre-association messaging.

In various embodiments, the process 900 may generate one or more wireless frames (block 920). The process 900 may generate the wireless frame(s) at the multi-link client device. Examples of the wireless frame(s) may include an action frame, a public action frame, a probe request frame, a multi-link probe request frame, an ANQP frame, a pre-association request frame, an authentication frame, an association request frame, or a reassociation request frame. In more embodiments, among other fields such as an FCS field, the wireless frame(s) may include a MAC header and a variable length frame body. Among other fields such as a duration field, supplementary address fields, and optional control fields, the MAC header may include, for example, a frame control field, an RA field, and a TA field. The frame control field may include a type field and a subtype field, configured to define the function of the wireless frame(s). For example, along with type 00, the subtype 0000 may define an association request frame, a subtype 0010 may define a reassociation request frame, a subtype 0100 may define a probe request frame, and a subtype 1101 may define an action frame. In the MAC header, the RA field may indicate an address of an intended receiver of the wireless frame(s) and the TA field may indicate an address of a transmitter of the wireless frame(s).

In additional embodiments, the process 900 may indicate the transmitted IRM address as a physical address in the one or more wireless frames (block 930). The process 900 may indicate the transmitted IRM address as a physical address in the wireless frame(s) at the multi-link client device. In further embodiments, the process 900 may utilize the previously transmitted single IRM address as a transmitter address, for example, in a subsequent association or in pre-association messaging. In still more embodiments, the process 900 may indicate the transmitted IRM address as the physical address in the TA field of the wireless frame(s). In still further embodiments, the process 900 may indicate the transmitted IRM address as the physical address in an MLD MAC address field of the wireless frame(s). In still additional embodiments, the MLD MAC address field may be included in a multi-link element of the wireless frame(s). In some more embodiments, the multi-link element may correspond to one of a basic multi-link element or a probe request multi-link element.

In yet various embodiments, the process 900 may transmit the one or more wireless frames (block 940). The process 900 may transmit the wireless frame(s) from the multi-link client device to the network device. The process 900 may transmit the wireless frame(s) for one of an MLO or a non-MLO. In yet more embodiments, based on the transmission of the wireless frame(s) for the MLO, the process 900 may indicate the IRM address as the physical address in the MLD MAC address field of the wireless frame. In still yet more embodiments, the process 900 may transmit, for the non-MLO, a new wireless frame indicating the IRM address in the TA field of the new wireless frame. In many further embodiments, based on the transmission of the wireless frame(s) for the non-MLO, the process 900 may indicate the IRM address as the physical address in the TA field of the wireless frame(s). In many additional embodiments, the process 900 may transmit, for the MLO, a new wireless frame indicating the IRM address in the MLD MAC address field of the new wireless frame. The network device may be an AP MLD that operates as an AP to connect the multi-link client device to the network. The network device may recognize the multi-link client device by utilizing the IRM address in the wireless frame(s).

Although a specific embodiment for a process 900 for providing MAC address randomization support for a multi-link client device suitable for carrying out the various steps, processes, methods, and operations described herein is discussed with respect to FIG. 9, any of a variety of systems and/or processes may be utilized in accordance with embodiments of the disclosure. For example, in still yet further embodiments, the process 900 may implement an RCM management protocol through which the multi-link client device can exchange IRM address rotation control and/or management information that may allow the network device to prompt a one or more STAs of the multi-link client device to execute an RCM action and, in some instances, may provide a frequency or other timing information related to the RCM action to facilitate IRM address rotations for the STA(s) in the network. The RCM management protocol can be used to influence when the STAs may rotate their respective IRM addresses, which may involve providing a frequency for the IRM address rotations that can be performed by the STA(s), providing timing information indicating when an STA may perform an IRM address rotation, facilitating triggered rotation events, and/or variations and/or extensions thereof. The elements depicted in FIG. 9 may also be interchangeable with other elements of FIGS. 1-8 and FIGS. 10-13 as required to realize a particularly desired embodiment.

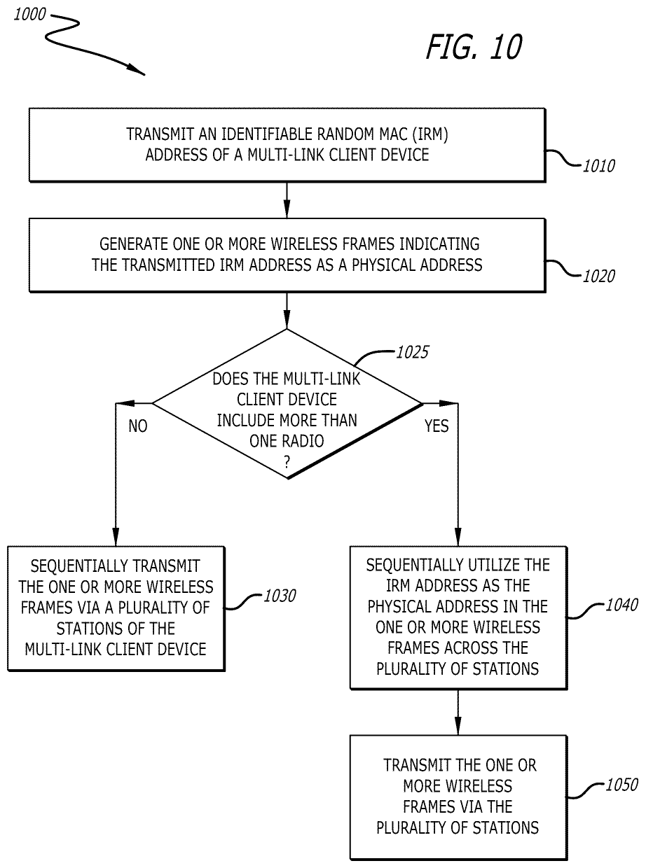

Referring to FIG. 10, a flowchart depicting a process 1000 for providing MAC address randomization support for a multi-link client device including one or more radios in accordance with various embodiments of the disclosure is shown. In many embodiments, the process 1000 may transmit an IRM address of a multi-link client device (block 1010). The process 1000 may transmit the IRM address from the multi-link client device. The IRM address may be configured to identify the multi-link client device each time the multi-link client device connects to a network via a network device, for example, an AP MLD. The network may be a WLAN, for example, a Wi-Fi network. The IRM address may be configured to be both randomized for privacy of the multi-link client device and still be identifiable by the network to which the multi-link client device connects. In a number of embodiments, the multi-link client device, for example, a tablet, a smartphone, a laptop, an IoT device, or the like, may be a non-AP MLD that does not operate as an AP. In a variety of embodiments, the multi-link client device may incorporate one or more radios, with each radio operating on a different frequency band or channel and maintaining communications with a corresponding radio on the network device that operates in that frequency band. The process 1000 may transmit the IRM address in an IRM KDE element of a wireless frame. For example, the process 1000 may transmit a single IRM address in Message 4 of a four-way handshake with the network device, by utilizing the IRM KDE of the wireless frame. The network device may utilize this single IRM address to recognize the multi-link client device, for example, in a subsequent association or in pre-association messaging.

In various embodiments, the process 1000 may generate one or more wireless frames indicating the transmitted IRM address as a physical address (block 1020). Examples of the wireless frame(s) may include an action frame, a public action frame, a probe request frame, a multi-link probe request frame, an ANQP frame, a pre-association request frame, an authentication frame, an association request frame, or a reassociation request frame. In more embodiments, among other fields such as an FCS field, the wireless frame(s) may include a MAC header and a variable length frame body. Among other fields such as a duration field, supplementary address fields, and optional control fields, the MAC header may include, for example, a frame control field, an RA field, and a TA field. The frame control field may include a type field and a subtype field, configured to define the function of the wireless frame(s). The process 1000 may indicate the transmitted IRM address as a physical address in the wireless frame(s) at the multi-link client device. In additional embodiments, the process 1000 may utilize the previously transmitted single IRM address as a transmitter address, for example, in a subsequent association or in pre-association messaging. In further embodiments, the process 1000 may indicate the transmitted IRM address as the physical address in the TA field of the wireless frame(s). In still more embodiments, the process 1000 may indicate the transmitted IRM address as the physical address in an MLD MAC address field of the wireless frame(s). In still further embodiments, the MLD MAC address field may be included in a multi-link element of the wireless frame(s). In still additional embodiments, the multi-link element may correspond to one of a basic multi-link element or a probe request multi-link element.

In some more embodiments, the process 1000 may determine whether the multi-link client device includes more than one radio (block 1025). For an MLO, the multi-link client device, which does not operate as an AP, may include multiple affiliated STAs. In yet various embodiments, the IRM address in the wireless frame(s) may identify at least one STA of the affiliated STAs of the multi-client device. In yet more embodiments, the process 1000 may implement the STAs through one or more radios of the multi-client device.

In still yet more embodiments, in response to determining that the multi-link client device does not include more than one radio, the process 1000 may sequentially transmit the one or more wireless frames via a plurality of stations of the multi-link client device (block 1030). The stations may also be referred to as “STAs.” In many further embodiments, the multi-link client device may be a single radio, multi-link client device including one radio. In many additional embodiments, for the single-radio, multi-link client device including one radio, the process 1000 may sequentially transmit the wireless frame(s) via the STAs across multiple frequency bands, one at a time. The single-radio, multi-link client device may perform active scanning, for example, by transmitting probe request frames, using the same radio across multiple frequency bands such as the 2.4 GHz band, the 5 GHz band, and the 6 GHz band, one by one. In still yet further embodiments, the process 1000 may utilize the same transmitted IRM address as a transmitter address in the TA field of the wireless frame(s) when scanning across the frequency bands.

In still yet additional embodiments, in response to determining that the multi-link client device includes more than one radio, the process 1000 may sequentially utilize the IRM address as the physical address in the one or more wireless frames across the plurality of stations (block 1040). In several embodiments, the multi-link client device may be a multi-radio, multi-link client device including multiple radios. For a multi-radio, multi-link client device that cannot perform scanning using the same radio on all frequency bands, in several more embodiments, the process 1000 may perform scanning by utilizing only one radio at a time and by utilizing the IRM address as the transmitter address in the TA field of a wireless frame on that radio operating, for example, at 2.4 GHz. The process 1000 may then pass the IRM address to the other radio operating, for example, at 5 GHz or 6 GHz, and utilize the same IRM address to perform scanning on the other frequency bands, for example, the 5 GHz band or the 6 GHz band, thereby allowing the network device to recognize at least one STA of the multi-radio client device because a recognized IRM address is utilized in every wireless frame transmitted for active scanning.

In numerous embodiments, the process 1000 can perform scanning in parallel by utilizing multiple radios. In these embodiments, only one of the radios may utilize the IRM address as the transmitter address when scanning. Each of the other radios may utilize a different IRM address which may not be recognized by the network device. This approach may only allow the network device to recognize the IRM address of one of the STAs of the multi-radio client device in a pre-association scan. In numerous additional embodiments, the process 1000 may utilize the same IRM address as the transmitter address for its pre-association traffic on multiple radios. The STAs of the multi-radio, multi-link client device may, therefore, appear as a single MAC address over multiple frequency bands to the network device. As the STAs are on the same multi-radio, multi-link client device, the duplication of the MAC address is a non-issue.

In numerous further embodiments, the process 1000 may transmit the one or more wireless frames via the plurality of stations (block 1050). The process 1000 may transmit the wireless frame(s) from the multi-link client device to the network device. The process 1000 may transmit the wireless frame(s) for one of an MLO or a non-MLO. In many embodiments, based on the transmission of the wireless frame(s) for the MLO, the process 1000 may indicate the IRM address as the physical address in the MLD MAC address field of the wireless frame. In a number of embodiments, the process 1000 may transmit, for the non-MLO, a new wireless frame indicating the IRM address in the TA field of the new wireless frame. In a variety of embodiments, based on the transmission of the wireless frame(s) for the non-MLO, the process 1000 may indicate the IRM address as the physical address in the TA field of the wireless frame(s). In various embodiments, the process 1000 may transmit, for the MLO, a new wireless frame indicating the IRM address in the MLD MAC address field of the new wireless frame. The network device may be an AP MLD that operates as an AP to connect the multi-link client device to the network. The network device may recognize the multi-link client device by utilizing the IRM address in the wireless frame(s).

Although a specific embodiment for a process 1000 for providing MAC address randomization support for a multi-link client device including one or more radios suitable for carrying out the various steps, processes, methods, and operations described herein is discussed with respect to FIG. 10, any of a variety of systems and/or processes may be utilized in accordance with embodiments of the disclosure. For example, in more embodiments, in an MLO, the process 1000 may transmit the wireless frames simultaneously across the available radios. The multi-link client device does not have to wait for a single radio to complete its transmission before another starts. Each radio can operate in parallel, transmitting parts of the data stream. The elements depicted in FIG. 10 may also be interchangeable with other elements of FIGS. 1-9 and FIGS. 11-13 as required to realize a particularly desired embodiment.

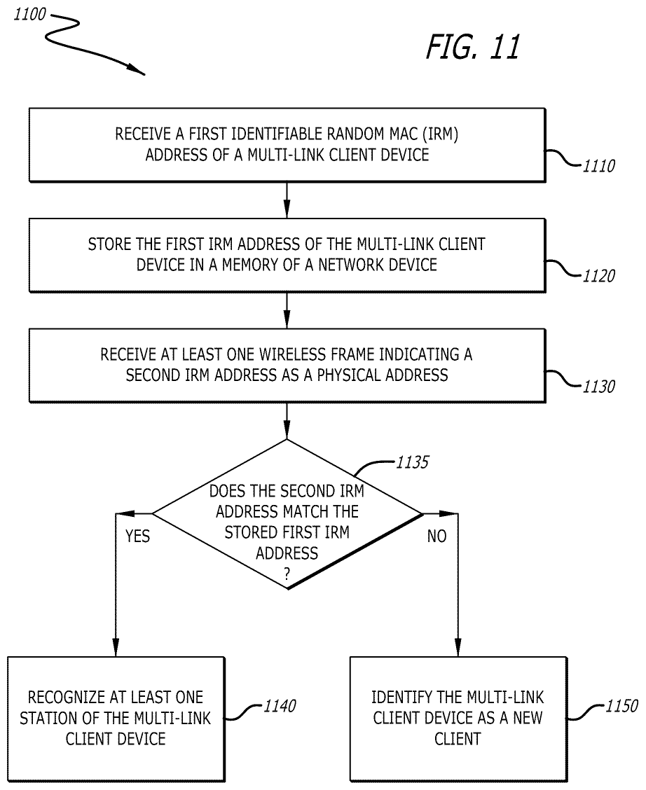

Referring to FIG. 11, a flowchart depicting a process 1100 for recognizing at least one station of a multi-link client device in accordance with various embodiments of the disclosure is shown. In many embodiments, the process 1100 may receive a first IRM address of a multi-link client device (block 1110). The process 1100 may receive the first IRM address of the multi-link client device from the multi-link client device. In a variety of embodiments, the multi-link client device, for example, a tablet, a smartphone, a laptop, an IoT device, or the like, may be a non-AP MLD that does not operate as an AP. The process 1100 may receive the first IRM address of the multi-link client device at a network device. The network device may, for example, be an AP MLD operating as an AP. The first IRM address may be configured to identify the multi-link client device each time the multi-link client device connects to a network via the network device. The network may be a WLAN, for example, a Wi-Fi network. The first IRM address may be configured to be both randomized for privacy of the multi-link client device and still be identifiable by the network to which the multi-link client device connects. The process 1100 may receive the first IRM address from an IRM KDE element of a wireless frame. For example, the process 1100 may receive the first IRM address from Message 4 of a four-way handshake with the multi-link client device, by utilizing the IRM KDE of the wireless frame.

In a number of embodiments, the process 1100 may store the first IRM address of the multi-link client device in a memory of a network device (block 1120). The memory may include, for example, a Read-Only Memory (ROM), an Electrically Erasable Programmable Read-Only Memory (EEPROM), or a flash memory. In various embodiments, the memory may include a Random Access Memory (RAM) configured to store the first IRM address. In more embodiments, the process 1100 may store the first IRM address of the multi-link client device in a data structure associated with a network interface such as a Network Interface Control Block (NICB) of the network device, or on the firmware of the network device.

In additional embodiments, the process 1100 may receive at least one wireless frame indicating a second IRM address as a physical address (block 1130). Examples of the wireless frame(s) may include an action frame, a public action frame, a probe request frame, a multi-link probe request frame, an ANQP frame, a pre-association request frame, an authentication frame, an association request frame, or a reassociation request frame. The process 1100 may receive the wireless frame(s) indicating the second IRM address as the physical address at the network device. The reception of the wireless frame(s) may be for one of an MLO or a non-MLO. In further embodiments, the second IRM address may be indicated as a physical address in a TA field of the wireless frame(s). In still more embodiments, the second IRM address may be indicated as a physical address in an MLD MAC address field of the wireless frame(s). In still further embodiments, the MLD MAC address field may be included in a multi-link element of the wireless frame(s). In still additional embodiments, the multi-link element may correspond to one of a basic multi-link element or a probe request multi-link element.

In some more embodiments, the process 1100 may determine whether the second IRM address matches the stored first IRM address (block 1135). The process 1100 may compare the second IRM address with the stored first IRM address to determine a match. The process 1100 may compare the second IRM address with a list of addresses stored in the memory of the network device to determine the match of the second IRM address with the stored first IRM address. The process 1100 may extract the second IRM address from the TA field or the MLD MAC address field of the received wireless frame(s) to perform the comparison with the addresses stored in the memory.

In yet various embodiments, in response to determining that the second IRM address matches the stored first IRM address, the process 1100 may recognize at least one station of the multi-link client device (block 1140). The process 1100 may recognize at least one STA of the multi-link client device at the network device. The match of the second IRM address in the TA field or the MLD MAC address field of the wireless frame(s) with the first IRM address stored in the memory may help the network device to recognize the STA(s) as a previously-associated STA. The RCM support for the MLD provided by the process 1100 also allows each affiliated STA of the multi-link client device to be recognized in a subsequent association or in pre-association messaging, for example, in a probe request. In yet more embodiments, the process 1100 may transmit another wireless frame including an IRM status field in an IRM element to the multi-link client device. The IRM status field may indicate whether the multi-link client device is recognized by the network device. In an example, when transmitted from the network device to the multi-link client device, the IRM status field may include a value of “0” indicating that the second IRM address and in turn the multi-link client device has been recognized by the network device.

In still yet more embodiments, in response to determining that the second IRM address does not match the stored first IRM address, the process 1100 may identify the multi-link client device as a new client (block 1150). The process 1100 may identify the multi-link client device as a new client at the network device. When the second IRM address in the TA field or the MLD MAC address field of the wireless frame(s) does not match with the first IRM address stored in the memory, the process 1100 may identify the multi-link client device as unrecognized and identify the multi-link client device as a new client. In many further embodiments, the process 1100 may transmit another wireless frame including an IRM status field in an IRM element to the multi-link client device. The IRM status field may indicate whether the multi-link client device is recognized by the network device. In an example, when transmitted from the network device to the multi-link client device, the IRM status field may include a value of “1” indicating that the second IRM address and in turn the multi-link client device has not been recognized by the network device.

Although a specific embodiment for a process 1100 for recognizing at least one station of a multi-link client device suitable for carrying out the various steps, processes, methods, and operations described herein is discussed with respect to FIG. 11, any of a variety of systems and/or processes may be utilized in accordance with embodiments of the disclosure. For example, in many additional embodiments, the process 1100 may utilize different methods to indicate recognition of the multi-link client device, such as a Fast BSS Transition (FT) feature where the network device may transmit an FT action frame or include FT parameters in a reassociation response to signal recognition and support for fast transition. The elements depicted in FIG. 11 may also be interchangeable with other elements of FIGS. 1-10 and FIGS. 12-13 as required to realize a particularly desired embodiment.

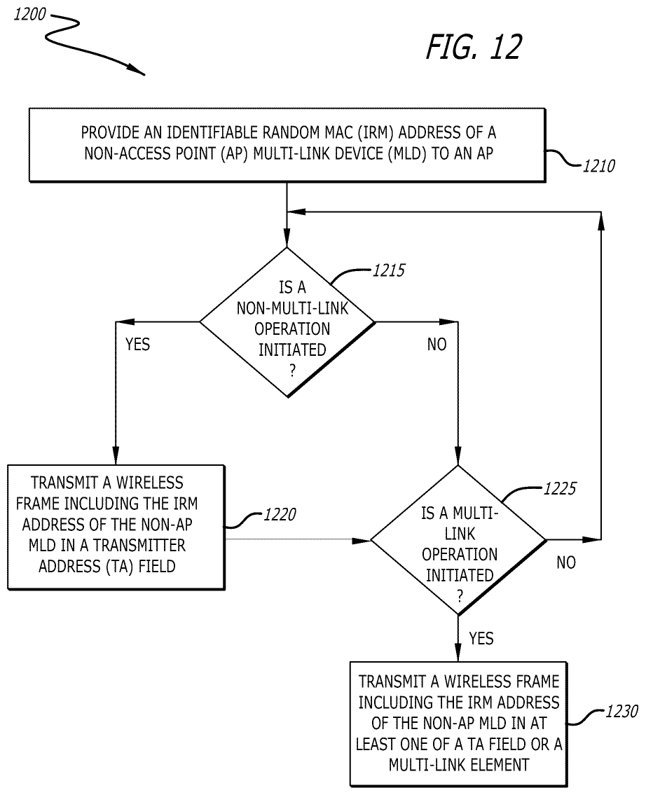

Referring to FIG. 12, a flowchart depicting a process 1200 for signaling one or more IRM addresses between multi-link operation and non-multi-link operation transitions in accordance with various embodiments of the disclosure is shown. In many embodiments, the process 1200 may provide an IRM address of a non-AP MLD to an AP (block 1210). The process 1200 may provide the IRM address from the non-AP MLD. The non-AP MLD may, for example, be a tablet, a smartphone, a laptop, an IoT device, or the like. The IRM address may be configured to identify the non-AP MLD each time the non-AP MLD connects to a network via the AP. The network may be a WLAN, for example, a Wi-Fi network. The AP may be an AP MLD or an AP non-MLD. The IRM address may be configured to be both randomized for privacy of the non-AP MLD and still be identifiable by the network to which the non-AP MLD connects. In an example case scenario where the AP is an AP MLD, the non-AP MLD may perform a multi-link setup with the AP MLD. In the multi-link setup, one or more radios of the non-AP MLD may communicate with the AP MLD simultaneously over different wireless links at the same time. In this example case scenario, the non-AP MLD may provide the IRM address that identifies the non-AP MLD, as part of the multi-link setup, during a four-way handshake.

In a number of embodiments, the process 1200 may determine whether a non-multi-link operation is initiated (block 1215). The non-multilink operation may be herein referred to as the “non-MLO.” The non-MLO may refer to a communication scenario where the non-AP MLD utilizes only a single wireless link or a single frequency band, for example, the 2.4 GHz band or the 5 GHz band, at a time to transmit and receive data. In a variety of embodiments, the process 1200 may determine whether the non-MLO is supported by the AP, for example, from one or more wireless frames that contain information on MLO-capabilities of the AP to determine whether the non-MLO is initiated. In various embodiments, the process 1200 may transmit a probe request frame or another pre-association request frame which is not MLO/MLD specific to the AP to indicate initiation of the non-MLO.

In more embodiments, in response to determining that the non-MLO is initiated, the process 1200 may transmit a wireless frame including the IRM address of the non-AP MLD in a TA field (block 1220). When one of the affiliated STAs of the non-AP MLD transmits a pre-association request frame, for example, a probe request frame, an ANQP frame, or the like, which is not MLO or MLD specific, then the affiliated STA may operate as a non-MLD STA. In this case, in accordance with the 802.11be amendment, the MAC address of the STA may be set to the MLD MAC address. Hence, the IRM address previously provided for the non-AP MLD can be utilized by the affiliated STA of the non-AP MLD, if the affiliated STA intends to reveal its identity. In that case, the MAC address in the TA field of the pre-association frame can be set to the IRM address previously provided during the multi-link setup, if the affiliated STA intends to be recognized by the AP MLD. When transmitting the non-MLO pre-association frames, the affiliated STA of the non-AP MLD transmitting a non-MLO pre-association frame may set the MAC address in the TA field of the non-MLO pre-association frame to the IRM address previously provided to the AP MLD in the same ESS, when the affiliated STA intends to be identified.

In further embodiments, in response to determining that the non-MLO is not initiated, the process 1200 may determine whether a multi-link operation is initiated (block 1225). The multi-link operation may be herein referred to as the “MLO.” The MLO may allow the non-AP MLD that are connected to the AP, to simultaneously operate across multiple channels in different frequency bands including, for example, the 2.4 gigahertz (GHz) band, the 5 GHz band, and the 6 GHz band, and maintain simultaneous connections to the frequency bands on a single AP. The MLO may, therefore, allow the non-AP MLD connected to the AP to simultaneously transmit and/or receive data across different frequency bands and channels. The MLO may aggregate multiple channels on different frequency bands at the same time, negotiating seamless network traffic even if there is an interference or a congestion in the network. In additional embodiments, the process 1200 may determine the initiation of the MLO, for example, from an MLO-specific pre-association frame transmitted by one of the affiliated STAs of the non-AP MLD. The MLO-specific pre-association frame may, for example, be a multi-link probe request frame.

In still more embodiments, in response to determining that the MLO is initiated, the process 1200 may transmit a wireless frame including the IRM address of the non-AP MLD in at least one of a TA field or a multilink element (block 1230). When one of the affiliated STAs of the non-AP MLD transmits an MLO-specific pre-association frame, for example, a multi-link probe request frame that includes a probe request multi-link element, the IRM address can be provided in the TA field or the multi-link element of the multi-link probe request frame. In still further embodiments, the affiliated STA of the non-AP MLD may provide the IRM address in the TA field of the multi-link probe request frame, which may keep the presence of the IRM address ambiguous and preclude an observer from determining that the MAC address in the TA field is the IRM address, because the TA field is always present whether the IRM address is utilized or not. In still additional embodiments, the affiliated STA of the non-AP MLD, when transmitting a multi-link probe request frame, may provide the IRM address in an MLD MAC address field of a basic multi-link element. In some more embodiments, the affiliated STA of the non-AP MLD may include the basic multi-link element only in the multi-link probe request frame, which is an MLO-specific pre-association frame.

In yet various embodiments, the affiliated STA of the non-AP MLD may provide the IRM address as the MLD MAC address in the probe request multi-link element. In yet more embodiments, the probe request multi-link element can be enhanced to include the MLD MAC address of an originator non-AP MLD which can then be set to the IRM address provided by the non-AP MLD in the previous multi-link setup, to provide the IRM address to the AP MLD. In still yet more embodiments, a non-AP MLD that previously provided an IRM address to an AP MLD in an ESS and later associates with an AP within the same ESS, may provide that IRM address as the MAC address in the TA field in authentication and (re)association request frames if the non-AP MLD intends to be identified by the AP in that ESS. In many further embodiments, when the non-AP MLD later performs another multi-link setup with an AP MLD in the same ESS, where the non-AP MLD provided the IRM address in the last multi-link association, the non-AP MLD may set the IRM address in the MLD MAC address field in the basic multi-link element of the authentication and (re)association request frames. In many additional embodiments, the non-AP MLD can also set the same IRM address in the TA field of the authentication and (re)association request frames, since the 802.11be draft amendment allows the STA MAC address and the MLD MAC address to be the same. In still yet further embodiments, when transmitting MLD level frames to another AP MLD including a multi-link probe request frame, an authentication request frame, and an association request frame, the non-AP MLD may set the MLD MAC address field in the basic multi-link element of each of the frames to the provided IRM address when the non-AP MLD intends to be identified.

In still yet additional embodiments, an affiliated STA of a non-AP MLD that previously provided an IRM address to an AP in an ESS and later associates with an AP MLD within the same ESS, may provide that IRM address as its MLD MAC address in the basic multi-link element of the multi-link probe request frame, the authentication request frame, and the (re)association request frame if the affiliated STA intends to be identified by the AP MLD in that ESS. In several embodiments, the non-AP MLD may set the IRM address provided previously both in the TA field and in the MLD MAC address field of the basic multi-link element in the pre-association frames such as the multi-link probe request frame, the authentication request frame, and the (re)association request frame.

In several more embodiments, in response to determining that the multilink operation is not initiated, the process 1200 may reiterate the step of determining whether the non-multilink operation is initiated (block 1215). For any non-MLO pre-association frame, for example, a non-multi-link probe request frame or an ANQP frame, the TA field of the non-MLO pre-association frame may be set to the IRM address, independent of whether the IRM address was provided as part of an MLO association or a non-MLO association, which may optimize the logic of the multi-link client device. This may also optimize the logic of the AP, since if the non-AP MLD sets both the TA field and the MLD MAC address field to the IRM address, then the AP may merely inspect the TA field to find the IRM address to recognize the affiliated STA of the non-AP MLD.

Although a specific embodiment for a process 1200 for signaling one or more IRM addresses between multi-link operation and non-multi-link operation transitions suitable for carrying out the various steps, processes, methods, and operations described herein is discussed with respect to FIG. 12, any of a variety of systems and/or processes may be utilized in accordance with embodiments of the disclosure. For example, in numerous embodiments, device firmware or driver software of the non-AP MLD can handle the signaling of IRM address transitions between the MLO and the non-MLO, in coordination with the AP. The elements depicted in FIG. 12 may also be interchangeable with other elements of FIGS. 1-11 and FIG. 13 as required to realize a particularly desired embodiment.

Referring to FIG. 13, a conceptual block diagram of a device 1300 suitable for configuration with a communication logic 1324 in accordance with various embodiments of the disclosure is shown. The embodiment of the device 1300 in the conceptual block diagram depicted in FIG. 13 may relate to a conventional server computer, a client device such as a non-AP MLD, a workstation, a desktop computer, a laptop, a tablet, a network appliance, an electronic reader (e-reader), a smartphone, or other computing device, and can be utilized to execute any of the application and/or logic components presented herein. The device 1300 may, in some examples, correspond to a physical device or to a virtual resource described herein. The device 1300 can also be a network device, for example, an access point such as an AP MLD or an AP non-MLD, a router, a switch, or any other edge-based network device in accordance with various embodiments of the disclosure.

In many embodiments, the device 1300 may include an environment 1302 such as a baseboard or a “motherboard,” in physical embodiments that can be configured as a printed circuit board with a multitude of components or devices connected by way of a system bus or other electrical communication paths. Conceptually, in virtualized embodiments, the environment 1302 may be a virtual environment that encompasses and executes the remaining components and resources of the device 1300. In a number of embodiments, one or more processors 1304, such as, but not limited to, CPUs can be configured to operate in conjunction with a chipset 1306. The processor(s) 1304 can be standard programmable CPUs that perform arithmetic and logical operations necessary for the operation of the device 1300.

In a variety of embodiments, the processor(s) 1304 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1306 may provide an interface between the processor(s) 1304 and the remainder of the components and devices within the environment 1302. The chipset 1306 can provide an interface to a RAM 1308, which can be utilized as the main memory in the device 1300 in some embodiments. The chipset 1306 can further be configured to provide an interface to a computer-readable storage medium such as a ROM 1310 or a Non-Volatile RAM (NVRAM) for storing basic routines that can help with various tasks such as, but not limited to, starting up the device 1300 and/or transferring information between the various components and devices. The ROM 1310 or NVRAM can also store other application components necessary for the operation of the device 1300 in accordance with various embodiments described herein.

Different embodiments of the device 1300 can be configured to operate in a networked environment using logical connections to remote computing devices and computer systems through a network, such as the network 1340 (shown as “LAN 1340”). The chipset 1306 can include functionality for providing network connectivity through a Network Interface Controller (NIC) 1312, which may include a gigabit Ethernet adapter or similar component. The NIC 1312 can be capable of connecting the device 1300 to other devices over the network 1340. It is contemplated that multiple NICs 1312 may be present in the device 1300, connecting the device 1300 to other types of networks and remote systems.

In more embodiments, the device 1300 can be connected to a storage 1318 that provides non-volatile storage for data accessible by the device 1300. The storage 1318 can, for example, store an operating system 1320, applications or programs 1322, device data 1328, frame data 1330, and link data 1332, which are described in greater detail below. The storage 1318 can be connected to the environment 1302 through a storage controller 1314 connected to the chipset 1306. In additional embodiments, the storage 1318 can include one or more physical storage units. The storage controller 1314 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1300 can store data within the storage 1318 by transforming the physical state of the physical storage units to reflect the information being stored. The specific transformation of the physical state can depend on various factors. Examples of such factors can include, but are not limited to, the technology utilized to implement the physical storage units, whether the storage 1318 is characterized as primary or secondary storage, and the like. For example, the device 1300 can store information within the storage 1318 by issuing instructions through the storage controller 1314 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1300 can further read or access information from the storage 1318 by detecting the physical states or characteristics of one or more particular locations within the physical storage units.

In addition to the storage 1318 described above, the device 1300 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1300. In some examples, the operations performed by a cloud computing network, and or any components included therein, may be supported by one or more devices similar to the device 1300. Stated otherwise, some or all of the operations performed by the cloud computing network, and or any components included therein, may be performed by the device 1300 operating in a cloud-based arrangement.

By way of example, and not limitation, computer-readable storage media can include volatile, non-volatile, removable, and non-removable media implemented in any method or technology. Computer-readable storage media includes, but is not limited to, RAM, ROM, Erasable Programmable ROM (EPROM), EEPROM, flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1318 can store an operating system 1320 utilized to control the operation of the device 1300. According to one embodiment, the operating system 1320 includes the LINUX operating system. According to another embodiment, the operating system 1320 includes the Windows server operating system from Microsoft Corporation of Redmond, Washington. According to further embodiments, the operating system 1320 can include the UNIX operating system or one of its variants. It should be appreciated that other operating systems can also be utilized. The storage 1318 can store other system or application programs and data utilized by the device 1300.

In still more embodiments, the storage 1318 or other computer-readable storage media is encoded with computer-executable instructions which, when loaded into the device 1300, may transform the device 1300 from a general-purpose computing system into a special-purpose computer capable of implementing the embodiments described herein. These computer-executable instructions may be stored as applications or programs 1322 and transform the device 1300 by specifying how the processor(s) 1304 can transition between states, as described above. In still further embodiments, the device 1300 has access to computer-readable storage media storing computer-executable instructions which, when executed by the device 1300, perform the various processes described above with regard to FIGS. 1-12. In still additional embodiments, the device 1300 can also include computer-readable storage media having instructions stored thereupon for performing any of the other computer-implemented operations described herein.

In some more embodiments, the device 1300 can also include one or more input/output controllers 1316 for receiving and processing input from a number of input devices, such as a keyboard, a mouse, a touchpad, a touch screen, an electronic stylus, or other type of input device. Similarly, an input/output controller 1316 can be configured to provide output to a display, such as a computer monitor, a flat panel display, a digital projector, a printer, or other type of output device. Those skilled in the art will recognize that the device 1300 may not include all of the components shown in FIG. 13, and can include other components that are not explicitly shown in FIG. 13, or may utilize an architecture completely different than that shown in FIG. 13.

As described above, the device 1300 may support a virtualization layer, such as one or more virtual resources executing on the device 1300. In some examples, the virtualization layer may be supported by a hypervisor that provides one or more virtual machines running on the device 1300 to perform functions described herein. The virtualization layer may generally support a virtual resource that performs at least a portion of the techniques described herein.

In yet various embodiments, the device 1300 can include a communication logic 1324 that may be responsible for providing MAC address randomization support for MLDs. In yet more embodiments, the communication logic 1324 may operate in an automation system. In embodiments where the device 1300 corresponds to a multi-link client device, the communication logic 1324 can be configured to perform various operations such as, but not limited to, transmitting an IRM address of the multi-link client device, generating one or more wireless frames indicating the IRM address as a physical address, wherein the IRM address in each wireless frame of the wireless frame(s) identifies at least one station of the plurality of stations, and transmitting the wireless frame(s). In still yet more embodiments where the device 1300 corresponds to a network device, the communication logic 1324 can be configured to perform various operations such as, but not limited to, receiving first IRM address of the multi-link client device, storing the first IRM address of the multi-link client device in a memory, receiving at least one wireless frame indicating a second IRM address as a physical address, and recognizing at least one station of the multi-link client device based on a match of the second IRM address with the first IRM address.

Those skilled in the art will recognize that the communication logic 1324 can include various hardware and/or software deployments and can be configured in a variety of ways. In many additional embodiments, the communication logic 1324 can be configured as a standalone device, exist as a logic in another network device, be distributed among various network devices operating in tandem, or remotely operated as part of a cloud-based network management tool. In still yet further embodiments, one or more servers can be configured with the communication logic 1324 or can otherwise operate as the communication logic 1324. In still yet additional embodiments, the communication logic 1324 may operate on one or more servers connected to a communication network, for example, the Internet. The communication network can include wired networks or wireless networks. The communication logic 1324 can be provided as a cloud-based service that can service remote networks, such as, but not limited to, a deployed network. Further, in several embodiments, the communication logic 1324 may be operated as a distributed logic across multiple network devices. In an embodiment, the controller can operate as the communication logic 1324 or may have multiple devices operate as the communication logic 1324 in a distributed manner.

In several more embodiments, the storage 1318 can include device data 1328. In further embodiments, the device data 1328 may relate to data representative of the MLDs for which RCM is supported. The device data 1328 may include, for example, device identification data, number of radios, number of STA instances or AP instances, radio interface data, MLO-capability data, frequency band data, channel widths, aggregated bandwidth data, power management data, or the like associated with the MLDs. In numerous embodiments, the device data 1328 may utilized for establishing communication with other MLDs and non-MLDs for MLO and non-MLO transitions.

In further additional embodiments, the storage 1318 can include frame data 1330. The frame data 1330 may relate to data representative of one or more wireless frames transmitted between the MLDs and between the MLDs and the non-MLDs. The frame data 1330 may include, for example, frame type, duration, destination or receiver address, source or transmitter address, sequence control information, throughput information, BSSID, SSID, information elements, error correction information, capabilities, timestamp information, or the like. The frame data 1330 may utilized for determining the type of actions, functions, requests, or the like, needed for establishing communications between the MLDs and between the MLDs and the non-MLDs.

In many embodiments, the storage 1318 can include link data 1332. The link data 1332 may relate to data representative of one or more links established between the MLDs and between the MLDs and the non-MLDs. The link data 1332 may include, for example, link identification data, frequency band data, channel data, bandwidth data, link availability data, link status information, link quality metrics such as Signal-to-Noise (SNR) ratio, Received Signal Strength Indicator (RSSI), Link Quality Index (LQI), or the like, and link aggregation data. The link data may be utilized to establish one or more links between the MLDs and between the MLDs and the non-MLDs.

In a number of embodiments, data may be processed into a format (e.g., feature vectors) usable by a Machine Learning (ML) model 1326, and/or other pre-processing techniques. In several embodiments, the ML model 1326 may be any type of ML model, such as supervised models, reinforcement models, and/or unsupervised models. The ML model(s) 1326 may include one or more of linear regression models, logistic regression models, decision trees, Naïve Bayes models, neural networks, k-means cluster models, random forest models, and/or other types of ML models. In a variety of embodiments, the ML model 1326 may be configured to leverage multiple radio links simultaneously to improve throughput and reliability. In various embodiments, the ML model 1326 may be configured to analyze the device data 1328 and the link data 1332 to optimize the selection and optimization of the radio links.

The ML model 1326 may be configured to analyze the device data 1328, the frame data 1330, and the link data 1332 for providing MAC address randomization support for the MLDs. In various embodiments, the ML model 1326 may be utilized to identify various parameters to include in the device data 1328, the frame data 1330, and the link data 1332. For example, the ML model 1326 may analyze the device data 1328, the frame data 1330, and the link data 1332 and identify parameters that are required to augment the device data 1328, the frame data 1330, and the link data 1332. Once the parameters are identified, the communication logic 1324 may utilize the parameters to provide MAC address randomization support for the MLDs. For example, the ML model 1326 may be configured to receive the device data 1328, the frame data 1330, and the link data 1332. The communication logic 1324 may then utilize trained models to determine whether an IRM address must be included in a TA field or a multi-link element field of a wireless frame. In further embodiments, the ML model 1326 may also evaluate the network environment and determine whether a non-AP MLD should switch from 2.4 GHz to 5 GHz or 6 GHz for better throughput, or whether to aggregate links from multiple radios to improve bandwidth.

Although a specific embodiment for a device 1300 suitable for configuration with the communication logic 1324 for carrying out the various steps, processes, methods, and operations described herein is discussed with respect to FIG. 13, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the communication logic 1324 acts in tandem between the devices. The elements depicted in FIG. 13 may also be interchangeable with other elements of FIGS. 1-12 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A multi-link client device, comprising:
a plurality of stations;
one or more processors;
a network interface controller configured to provide access to a network; and
a memory communicatively coupled to the one or more processors, wherein the memory comprises a communication logic that is configured to:
transmit an Identifiable Random Media Access Control (IRM) address of the multi-link client device;
generate one or more wireless frames indicating the IRM address as a physical address, wherein the IRM address in each wireless frame of the one or more wireless frames identifies at least one station of the plurality of stations; and
transmit the one or more wireless frames.

2. The multi-link client device of claim 1, wherein a wireless frame of the one or more wireless frames corresponds to one of: an action frame, a public action frame, a probe request frame, a multi-link probe request frame, an access network query protocol frame, a pre-association request frame, an authentication frame, an association request frame, or a reassociation request frame.

3. The multi-link client device of claim 1, wherein the transmission of the IRM address comprises transmitting the IRM address in an IRM key delivery element of another wireless frame.

4. The multi-link client device of claim 1, wherein the communication logic is further configured to sequentially transmit the one or more wireless frames via the plurality of stations.

5. The multi-link client device of claim 1, wherein the communication logic is further configured to simultaneously transmit the one or more wireless frames via the plurality of stations.

6. The multi-link client device of claim 1, wherein the plurality of stations is implemented through one or more radios.

7. The multi-link client device of claim 6, wherein based on the one or more radios including a plurality of radios, the communication logic is further configured to sequentially utilize the IRM address as the physical address across the plurality of stations for the transmission of the one or more wireless frames.

8. The multi-link client device of claim 1, wherein the IRM address is indicated as the physical address in a transmitter address field of the one or more wireless frames.

9. The multi-link client device of claim 1, wherein the IRM address is indicated as the physical address in a multi-link device Media Access Control (MAC) address field of the one or more wireless frames.

10. The multi-link client device of claim 9, wherein the multi-link device MAC address field is included in a multi-link element of the one or more wireless frames.

11. The multi-link client device of claim 10, the multi-link element corresponds to one of a basic multi-link element or a probe request multi-link element.

12. The multi-link client device of claim 1, wherein the transmission of the one or more wireless frames is for one of a multi-link operation or a non-multi-link operation.

13. The multi-link client device of claim 12, wherein based on the transmission of the one or more wireless frames for the multi-link operation, the IRM address is indicated as the physical address in a multi-link device media access control address field of the one or more wireless frames.

14. The multi-link client device of claim 13, wherein the communication logic is further configured to transmit, for the non-multi-link operation, a new wireless frame indicating the IRM address in a transmitter address field of the new wireless frame.

15. The multi-link client device of claim 12, wherein based on the transmission of the one or more wireless frames for the non-multi-link operation, the IRM address is indicated as the physical address in a transmitter address field of the one or more wireless frames.

16. The multi-link client device of claim 15, wherein the communication logic is further configured to transmit, for the multi-link operation, a new wireless frame indicating the IRM address in a multi-link device media access control address field of the new wireless frame.

17. A network device, comprising:
one or more processors;
a network interface controller configured to provide access to a network; and
a memory communicatively coupled to the one or more processors, wherein the memory comprises a communication logic that is configured to:
receive a first Identifiable Random Media Access Control (IRM) address of a multi-link client device;
store the first IRM address of the multi-link client device in the memory;
receive at least one wireless frame indicating a second IRM address as a physical address; and
recognize at least one station of the multi-link client device based on a match of the second IRM address with the first IRM address.

18. The network device of claim 17, wherein the at least one wireless frame corresponds to one of: an action frame, a public action frame, a probe request frame, a multi-link probe request frame, an access network query protocol frame, a pre-association request frame, an authentication frame, an association request frame, or a reassociation request frame.

19. The network device of claim 17, wherein the reception of the at least one wireless frame is for one of a multi-link operation or a non-multi-link operation.

20. A method, comprising:
transmitting an Identifiable Random Media Access Control (IRM) address of a multi-link client device;
generating one or more wireless frames indicating the IRM address as a physical address, wherein the IRM address in each wireless frame of the one or more wireless frames identifies at least one station among a plurality of stations; and
transmitting the one or more wireless frames.
